(19) United States
(12) Patent Application Publication
(10) Pub. No.: US 2022/0305511 A1
(43) Pub. Date: Sep. 29, 2022

(54) DEVICE FOR MONITORING ROTATIONAL ATOMIZATION OF A COATING MATERIAL COMPOSITION

(71) Applicant: BASF Coatings GmbH, Münster (DE)

(72) Inventors: Jan Christopher Holzapfel, Münster (DE); Georg Wigger, Münster (DE); Damiel Briesenick, Münster (DE); Kai Schaefer, Münster (DE); Harry Libutzki, Münster (DE)

(21) Appl. No.: 17/635,123

(22) PCT Filed: Aug. 20, 2020
(86) PCT No.: PCT/EP2020/073275

§ 371 Date: Feb. 14, 2022

(30) Foreign Application Priority Data
Aug. 20, 2019 (EP) 19192656.7

(51) Int. Cl. B05B 12/08; B05B 5/04; G01N 15/02

(52) U.S. Cl. CPC B05B 12/082; B05B 5/0407; G01N 15/0227; G01N 2015/0049

(57) ABSTRACT

Described herein is a device for performing and optically monitoring a rotational atomization of a coating material composition, where the device includes at least one rotational atomizer, which includes as application element a mountable bell cup capable of rotation, at least one supply unit for supplying the coating material composition to the rotational atomizer, at least one camera, and at least one optical measurement unit. Also described herein are a method of using the device for performing and optical monitoring the rotational atomization of the coating material composition and a method for determining the mean length of filaments formed on the edge of the bell cup of an rotational atomizer during the rotational atomization of the coating material composition and/or for determining at least one characteristic variable of the drop size distribution within a spray and/or the homogeneity of the spray.

The present invention relates to a device (1) for performing and optically monitoring a rotational atomization of a coating material composition, wherein said device (1) comprises at least one rotational atomizer (2), which comprises as application element a mountable bell cup (3) capable of rotation, at least one supply unit (4) for supplying the coating material composition to the rotational atomizer (2), at least one camera (5) and at least one optical measurement unit (6), a use of said device for performing and optical monitoring the rotational atomization of the coating material composition and to a method for determining the mean length of filaments formed on the edge of the bell cup of an rotational atomizer during said rotational atomization of the coating material composition and/or for determining at least one characteristic variable of the drop size distribution within a spray and/or the homogeneity of said spray, the spray being formed on said rotational atomization of the coating material composition, wherein said method is carried out by making use of the device (1).

### PRIOR ART AND BACKGROUND

Nowadays in the automobile industry in particular there is a range of coating material compositions, such as basecoat materials, that are applied by means of rotational atomization to the particular substrate that is to be coated. Such atomizers feature a fast-rotating application element such as a bell cup, for example, which atomizes the coating material composition to be applied, atomization taking place in particular by virtue of the acting centrifugal force, forming filaments, to produce a spray mist in the form of drops. The coating material composition is typically applied electrostatically, in order to maximize application efficiency and minimize overspray. At the edge of the bell cup, the coating material, atomized by means of centrifugal forces in particular, is charged by direct application of a high voltage to the coating material composition for application (direct charging). Following application of the respective coating material composition to the substrate, the resultant film—where appropriate following additional application of other coating material compositions over it, in the form of further films—is cured or baked to give the resultant desired coating.

Optimization of coatings, especially coatings obtained in this way, with regard to particular desired properties of the coating, such as prevention of or at least reduction in the tendency for formation and/or the incidence of optical defects and/or surface defects such as, for example, pinholes, cloudiness, and/or in the leveling properties, is comparatively complicated and is typically only possible by empirical means. This means that such coating material compositions or, typically, entire test series thereof, within which different parameters have been varied, must first be produced and then, as described in the preceding paragraph, must be applied to a substrate and cured or baked. After that, the series of coatings then obtained must be investigated with regard to the desired properties, in order to allow any possible improvement in the properties investigated to be assessed. Typically, this procedure has to be multiply repeated with further variation of parameters, until the desired improvement in the property or properties of the coating investigated, after curing and/or baking, has been achieved.

There is therefore a need for providing a means, which makes it possible, by investigating the atomization behavior of coating material compositions, to achieve an improvement in certain desired properties of the coatings to be produced by means of this atomization, such as the prevention of or at least reduction in the tendency for formation and/or the incidence of optical defects and/or surface defects, without having to go through the commonly required complete operation of coating and baking for producing such coatings.

In addition, there is a need for providing such a means, which allows a simple investigation to take place and enables fast and efficient paint development without having to necessarily block the capacities of conventional spray booths used for automotive OEM or refinish applications.

### Problem

A problem addressed by the present invention, therefore, is that of providing a means which makes it possible to investigate and more particularly to improve certain desired properties of coatings to be produced by rotational atomization, such as the prevention of or at least reduction in the tendency for formation and/or the incidence of optical defects and/or surface defects, without having to apply the respective coating material composition for use to a substrate by means of a conventional painting process and in particular without having to cure and/or bake the resulting film in order to produce the coating, since to do so is comparatively costly and inconvenient and is disadvantageous at least on economic grounds. At the same time such a means should allow a simple investigation to take place and should enable fast and efficient paint development without having to necessarily block the capacities of conventional spray booths used for automotive OEM or refinish applications.

### Solution

This problem is solved by the subject matter claimed in the claims and also by the preferred embodiments of that subject matter that are described in the description hereinafter.

A first subject-matter of the present invention is a device (1) for performing and optically monitoring a rotational atomization of a coating material composition, wherein said device (1) comprises

at least one rotational atomizer (2), which comprises as application element a mountable bell cup (3) capable of rotation,
at least one supply unit (4) for supplying a coating material composition to the rotational atomizer (2),
at least one camera (5) for optical capturing of filaments formed by atomization of the coating material composition at the edge of the bell cup (3) and
at least one optical measurement unit (6) for optical capturing of drops of a spray, which is formed by atomization of the coating material composition, by a traversing optical measurement through the entire spray.

A further subject-matter of the present invention is a use of the inventive device (1) for optically monitoring a rotational atomization of a coating material composition.

A further subject-matter of the present invention is a method for determining the mean length of filaments formed on the edge of the bell cup of an rotational atomizer during rotational atomization of a coating material composition and/or for determining at least one characteristic variable of the drop size distribution within a spray and/or the homogeneity of said spray, the spray being formed on rotational atomization of a coating material composition, characterized in that the method is carried out by making use of the inventive device (1).

It has surprisingly been found that the inventive device (1) allows a simple investigation with respect to improving certain desired properties of coatings to be produced by rotational atomization such as the prevention of or at least reduction in the tendency for formation and/or the incidence of optical defects and/or surface defects to take place, without having to apply the respective coating material composition for use to a substrate by means of a conventional painting process and in particular without having to cure and/or bake the resulting film in order to produce the coating. It has been further surprisingly found that the device (1) allows a fast and efficient paint development without having to necessarily block the capacities of conventional spray booths used for automotive OEM or refinish applications.

It has surprisingly been found that the inventive device (1) not only allows a determination of the mean length of filaments formed on the edge of the bell cup of an rotational atomizer during rotational atomization of a coating material composition and of at least one characteristic variable of the drop size distribution within a spray and/or the homogeneity of said spray, the spray being formed on rotational atomization of a coating material composition, performed one after another, but in particular alternatively also a determination of both the mean length of filaments and of the at least one characteristic variable of the drop size distribution/homogeneity of the spray simultaneously.

Surprisingly, by implementing the method of the invention on the basis of the mean filament lengths and/or ascertained, it is possible to achieve an investigation of and in particular an improvement in certain desired properties of coatings to be produced by means of rotational atomization, particularly with regard to preventing or at least reducing the tendency for formation and/or the incidence of optical defects and/or surface defects, without in this case having to apply the particular coating material composition for use to a substrate by means of a conventional painting procedure and to carry out curing and/or baking of the resulting film in order to produce the coating.

It has surprisingly been found that the method of the invention for screening coating material compositions in the development of paint formulations is less costly and therefore has (time-)economic and financial advantages over corresponding conventional methods. By the device (1) of the invention it is possible surprisingly, on the basis of the ascertained mean filament lengths and/or on the basis of the ascertained drop size distribution and/or the homogeneity, to estimate, with a sufficiently high probability, whether certain optical defects and/or surface defects can be expected in the coating to be produced, without producing the coating at all. This is accomplished, surprisingly, by determination of the mean lengths of the filaments which occur on atomization, located at the edge of the bell cup of the rotational atomizer and/or by determination of the drop size distribution and/or of the homogeneity of the drops which occur on atomization, forming the spray mist, and by a correlation of these ascertained characteristic variables and/or by a correlation of these ascertained filament lengths with the incidence of the aforesaid optical defects and/or surface defects, or their prevention/reduction. Depending on these mean filament lengths occurring during atomization, and/or depending on these particle size distributions occurring during atomization, and/or on the homogeneity of the drops it is possible accordingly to be able to monitor the resulting properties such as optical properties and/or surface properties of the coating to be produced and in particular to prevent or at least reduce the incidence of optical defects and/or surface defects. In other words, by means of the method of the invention, because of the investigation of the atomization behavior of a coating material composition, it is possible to make predictions regarding qualitative properties of the eventual coating (such as the incidence of pinholes, cloudiness, leveling, or appearance). The method of the invention as well as the inventive device (1) as such therefore permits a simple and efficient technique for quality assurance and enables purposive development of coating material compositions without need for recourse to comparatively costly and inconvenient coating procedures on (model) substrates. In particular it is possible here to omit the step of curing and/or baking.

### DETAILED DESCRIPTION

### Inventive Device (1)

The inventive device (1) comprises at least one rotational atomizer (2), which comprises as application element a mountable bell cup (3) capable of rotation, at least one supply unit (4) for supplying a coating material composition to the rotational atomizer (2), at least one camera (5) and at least one optical measurement unit (6).

### Atomizer (2) and Bell Cup (3)

The atomizer (2) of the device (1) is a rotational atomizer, which comprises as application element a mountable bell cup (3), which in turn is capable of rotation.

The concept of “rotational atomizing” or, preferably, of “high-speed rotational 20 atomizing”, which is achieved by making use of the atomizer (2), is one which is known to the skilled person. Such rotational atomizers feature a rotating application element that atomizes the coating material composition to be applied into a spray or spray mist in the form of drops, owing to the acting centrifugal force. The application element in this case is a bell cup (3), preferably a metallic bell cup (3).

In the course of rotational atomization by means of atomizers, so-called filaments develop first, at the edge of the bell cup (3), and then go on, in the further course of the atomization process, to break down further into aforesaid drops, which then form a spray or spray mist. The filaments therefore constitute a precursor of these drops. The filaments may be described and characterized by their filament length (also referred to as “thread length”) and their diameter (also referred to as “thread diameter”).

Optionally, the atomized coating material composition may undergo electrostatic charging at the edge of the bell cup (3) by the application of a voltage. This is, however, not necessary, but only optional, in case of the present invention.

The speed of rotation (rotational velocity) of the bell cup (3) of the atomizer (2) is adjustable. In the present case the rotation speed is preferably at least 10 000 revolutions/min (rpm) and at most 70 000 revolutions/min. The rotational velocity is preferably in a range from 15 000 to 70 000 rpm, more preferably in a range from 17 000 to 70 000 rpm, more particularly from 18 000 to 65 000 rpm or from 18 000 to 60 000 rpm. At a rotation speed of 15 000 revolutions per minute or above, a rotational atomizer of this kind, in the sense of this invention, is referred to preferably as a high-speed rotational atomizer. Rotational atomization in general and high-speed rotational atomization in particular are widespread within the automobile industry. The (high-speed) rotational atomizers used for these processes are available commercially; examples include products of the Ecobell® series from the company Dürr. Such atomizers are suitable preferably for electrostatic application of a multiplicity of different coating material compositions, such as paints, that are used in the automobile industry. Particularly preferred for use as coating material compositions within the method of the invention are basecoat materials, more particularly aqueous basecoat materials. The coating material composition may be applied electrostatically, but need not be. In the case of electrostatic application, there is electrostatic charging of the coating material composition, atomized by centrifugal forces, at the bell cup edge, by preferably direct application of a voltage such as a high voltage to the coating material composition that is to be applied (direct charging). Indirect charging is also possible. In this case drops are formed by atomizing the coating material, which are then charged “on flight” while forming the spray.

The discharge rate of the coating material composition to be atomized is adjustable. The discharge rate of the coating material composition for atomization is preferably in a range from 50 to 1000 ml/min, more preferably in a range from 100 to 800 ml/Min, very preferably in a range from 150 to 600 ml/min, more particularly in a range from 200 to 550 ml/min.

The discharge rate of the coating material composition for atomization is preferably in a range from 100 to 1000 ml/min or from 200 to 550 ml/min, and/or the rotary speed of the bell cup is in a range from 15 000 to 70 000 revolutions/min or from 15 000 to 60 000 rpm.

Preferably, the mountable bell cup (3) of the rotational atomizer (2) is straight serrated, cross serrated or non-serrated. The term “mountable” in this regard means that the bell cup (3) can be exchanged by another bell cup (3): for example, a non-serrated bell cup (3) may be exchanged with a cross serrated bell cup (3) depending on the nature and composition of the coating material composition used. For instance, the use of cross serrated bell cups (3) is particularly advantageous in case of clearcoats, the use of straight serrated bell cups (3) for basecoats and the use of non-serrated bell cups (3) for use of fillers/primers.

Preferably, the atomizer (2) of the device (1) is in a tilted position and the at least one camera (5) and the at least one optical measurement unit (6) are independently of each other each positioned within the device (1) in relation to the tilted atomizer (2) at a tilt angle in the range of from 0° to 90°, more preferably of from >0 to <90°, such as from 10 to 80°.

Preferably, the at least one rotational atomizer (2) has a fixed position within the device (1). Thus, preferably, the atomizer (2) is not movable. Preferably, the same applies to the supply unit (4). However, alternatively the at least one rotational atomizer (2) can have an adjustable position within the device (1), i.e., can be movable.

### Supply Unit (4)

The device (1) comprises at least one supply unit (4) for supplying a coating material composition to the rotational atomizer (2).

Preferably, the at least one supply unit (4) of the device (1) has a fixed position within the device (1). Thus, preferably, the supply unit (4) is not movable. Preferably, the same applies to the atomizer (2).

Preferably, the supply unit (4) contains the coating material composition. Preferably, the supply unit (4) of the device (1) comprises at least one container (4a), which can contain the coating material composition, in particular, when it is a 1K-coating material composition, as well as means (4b) for providing the coating material composition from the at least one container (4a) to the atomizer (2). Optionally, the supply unit (4) of the device (1) may comprise at least one further container (4c) containing water and/or at least one organic solvent. Water and/or organic solvent present in container (4c) and/or air pressure from a further optionally present air pressure unit can be used to rinse the paint supply after atomization.

It is also possible that the at least one container (4a) contains only part of the coating material composition, in particular, when it is a 2K-coating material composition. In this case, container (4a), may, e.g. comprise the “binder component” of the 2K-coating material composition and at least one further container (4d) may in turn contain the “crosslinker” component of the 2K-coating material composition. In this case supply unit (4) further preferably comprises a mixing unit for mixing at least the “binder component” and the “crosslinker component”. In this case, the supply unit (4) including the mixing unit further comprises one means (4b) such as a pipe for providing the mixed components to the atomizer (2). In addition, it is also possible that supply unit (4) preferably contains at least two means (4b), namely for providing the “binder component” from the at least one container (4a) to the atomizer (2) (1^{st} means) and for providing the “crosslinker component” from the at least one container (4d) to the atomizer (2) (2^{nd} means). This is in particular the case if 2K atomizers are used. Optionally, the supply unit (4) of the device (1) may comprise at least one further container (4c) containing water and/or at least one organic solvent. Water and/or organic solvent present in container (4c) and/or air pressure from a further optionally present air pressure unit can be used to rinse the paint supply after atomization.

Preferably, the supply unit (4) is a paint supply unit.

### Camera (5)

Preferably, both the at least one camera (5) and the at least one optical measurement unit (6) are movable and/or adjustable within the device (1). Adjustment can be in particularly achieved by means of electrical adjustments.

The camera (5) can be used to capture the atomization process optically at the bell cup edge of the bell cup (3) of the bell. In this way, information about the decomposition of filaments formed directly at the bell cup edge during the atomization can be obtained. The atomization process is preferably photographed, and/or a corresponding video recording is prepared by making use of the camera (5).

The camera (5) used is preferably a high-speed camera. Examples of such cameras are models from the Fastcam® range from Photron Tokyo, from Japan, such as the Fastcam® SA-Z model, for example.

Preferably, the at least one camera (5) is capable of recording at least 30 000 to 250 000 images of the bell cup (3) and its edge per second during atomization, more preferably 40 000 to 220 000 images per second, more preferably still 50 000 to 200 000 images per second, very preferably 60 000 to 180 000 images, even more preferably 70 000 to 160 000 images per second, and more particularly 80 000 to 120 000 images per second, of the bell cup (3) and more particularly of the bell cup edge. The resolution of the images may be set variably. For example, resolutions of 512×256 pixels per image are possible.

### Optical Measurement Unit (6)

The at least one optical measurement unit (6) allows optical capturing of drops of a spray, which is formed by atomization of the coating material composition, by a traversing optical measurement through the entire spray.

The implementation of the traversing measurement allows the entire spray, and hence the entire drop spectrum forming the spray, to be captured in its entirety. As a result, the capture of all of the drop sizes forming the spray is made possible. The spray can be measured in its entirety (and not just individual regions of the spray). The traversing measurement allows locationally resolved—i.e., point-specific—optical measurement of the drops at numerous locations in the atomization spray, being much more precise than if the measurement did not take place traversingly.

The at least one optical measurement unit (6) is preferably movable, in particular electrically movable, and/or adjustable within the device (1). In this case, the atomizing head of the atomizer (2) of the device is preferably at a fixed position. Adjustment can be in particularly achieved by means of electrical adjustments.

Preferably, the at least one optical measurement unit (6) contains at least one laser (7) or laser source (7) and allows performing of scattered light investigations on the drops contained within the spray formed upon atomization, and is carried out on these drops. This measurement is preferably accomplished using at least one laser (7).

Preferably, the at least one optical measurement unit (6) is a means for performing phase Doppler anemometry (PDA) and/or for performing time-shift technique (TS). From the optical data obtained by means of PDA, it is possible to determine at least one characteristic variable of the drop size distribution. From the optical data obtained by means of TS, it is possible to determine both at least one characteristic variable of the drop size distribution and the homogeneity of the spray.

Preferably, the at least one optical measurement unit (6) further contains at least one detector (9), which in particular allows detecting of the light scattered by the drops of the spray.

The procedure for determining the drop size distribution may take place by means of phase Doppler Anemometry (PDA) when the at least one optical measurement unit (6) is a means for performing phase Doppler anemometry (PDA). This technique is known fundamentally to the skilled person, from, for example, F. Onofri et al., Part. Part. Sys. Charact. 1996, 13, pages 112-124 and A. Tratnig et al., J. Food. Engin. 2009, 95, pages 126-134. The PDA technique is a measurement method based on the formation of an interference plane pattern in the intersection volume of two coherent laser beams. The particles moving in a flow, such as, for example, the drops of the atomization spray mist, i.e., spray, that are investigated in accordance with the present invention, scatter light, when passing through the intersection volume of the laser beams, with a frequency referred to as the Doppler frequency, which is directly proportional to the viscosity at the location of the measurement. From the difference in phase position of the scattered light signal at preferably at least two detectors used, these detectors being sited at different locations in the space, it is possible to determine the radius of curvature of the particle surface. In the case of spherical particles, this leads to the particle diameter; in the case of drops, therefore, it leads to the respective drop diameter. For high measurement accuracy it is advantageous to design the measuring system, particularly in relation to the scattering angle, in such a way that a single scattering mechanism (reflection or first-order refraction) is dominant. The scattered light signal is typically converted by photomultipliers into electronic signals, which are evaluated, using covariance processors or by means of an FFT analysis (Fast Fourier Transformation analysis), for the Doppler frequency and the difference in the phase positions. The use of a Bragg cell here makes it possible, preferably, to carry out controlled manipulation of the wavelength of one of the two laser beams, and so to generate an ongoing interference plane pattern. PDA systems measure the phase shifts (that is, the difference in the phase positions) customary in received light signals by using different receiving apertures (masks). In the case of implementation by means of PDA, a mask is preferably employed that can be used to detect drops having a maximum possible drop diameter of 518.8 μm.

Corresponding instruments suitable for implementing the PDA method are available commercially, an example being the Single-PDA from DantecDynamics (P60, Lexel argon laser, FibreFlow). Preferably, PDA is operated in forward scattering at an angle of 60-70° with a wavelength of 514.5 nm (polarized orthogonally) in reflection. The receiving optics in this case preferably have a focal length of 500 mm; the transmitting optics preferably having a focal length of 400 mm. Preferably, the optical measurement by means of PDA takes place traversingly in a radial-axial direction in relation to the tilted atomizer used, preferably at a 45° tilt angle. In principle, however, as mentioned above, tilt angles in a range from 0 to 90°, preferably >0 to <90°, such as from 10 to 80°, are possible. The optical measurement takes place preferably 25 mm vertically below the flank of the atomizer that is inclined to the traversing axis. Measurements have shown the process of drop formation to be concluded at this position. A defined traversing speed is preferably mandated, so that locational resolution of the individual events detected takes place via the associated time-resolved signals. A comparison with raster-resolved measurements yields identical results for the weighted global characteristic distribution values, but also allows the investigation of any desired interval ranges on the traversing axis. This technique, moreover, is more rapid by a multiple factor than rastering, thereby allowing the material expenditure to be reduced at constant flow rates.

The procedure for determining the drop size distribution may additionally or alternatively take place by means of time-shift technique (TS) when the at least one optical measurement unit (6) is a means for performing (TS). The time-shift technique (TS) is likewise fundamentally known to the skilled person, from, for example, an article by W. Schafer et al., ICLASS 2015, 13th Triennial International Conference on Liquid Atomization and Spray Systems, Tainan, Taiwan, pages 1 to 7, and an article by M. Kuhnhenn et al., ILASS Europe 2016, 27th Annual Conference on Liquid Atomization and Spray Systems, Sep. 4-7, 2016, Brighton UK, pages 1 to 8, and also from W. Schafer et al., Particuology 2016, 29, pages 80-85.

The time-shift technique (TS) is a measurement method which is based on the backscattering of light (e.g., laser light) by particles such as, in the case of the present invention, by the drops of the spray mist (spray) resulting from the atomization. The TS technique is based on the light scattering of an individual particle from a shaped light beam such as a laser beam. The scattered light of the individual particle is interpreted as the sum total of all orders of scattering present at the location of the detector used. In approximation to the geometric optics, this corresponds to the analysis of the propagation of individual light beams through the particle, with a varying number of internal reflections. The laser beam used for implementing the time-shift technique is typically focused by lenses. The light which has been scattered by the particles is divided into perpendicularly polarized and parallel-polarized light, and is captured separately by preferably at least two photodetectors. The signal coming from the detectors in turn supplies the necessary information for ascertaining a determination of the drop size distribution and/or homogeneity. The wavelength of the light of the illuminating beam used is in the same order of magnitude as or smaller than that of the particles to be measured. The laser beam ought therefore to be selected so that it does not exceed the size of the drops, in order to give the time-shift signal. If this value is exceeded, the signal is no longer a suitable basis for the determination of the size referred to above. Otherwise the problem arises that the signal components of the different scatterings overlap and can therefore not be captured and distinguished individually. The time-shift technique can be used for determining characteristic properties of the particles, such as for determining the drop size distribution. Moreover, the time-shift technique (TS) allows differentiation between bubbles, i.e., transparent drops (T), and solids-containing particles, i.e., nontransparent drops (NT).

Corresponding instruments suitable for these purposes are available commercially, examples being instruments from the SpraySpy® series from AOM Systems. The implementation of traversing measurements by means of instruments from the SpraySpy® series, while being fundamentally known, is nevertheless only utilized in the prior art in order to determine the width of the spray jet, but not in order to determine the homogeneity of the spray and/or characteristic variables of the drop size distribution.

The optical measurement by means of TS takes place preferably traversingly in a radial-axial direction in relation to the tilted atomizer used, preferably at a 45° tilt angle. In principle, however, as mentioned above, tilt angles in a range from 0 to 90°, preferably >0 to <90°, such as from 10 to 80°, are possible. The optical measurement takes place preferably 25 mm vertically below the bell cup of the atomizer that is inclined to the traversing axis. Measurements have shown the process of drop formation to be concluded at this position. A defined traversing speed is preferably mandated, so that locational resolution of the individual events detected takes place via the associated time-resolved signals. A comparison with raster-resolved measurements yields identical results for the weighted global characteristic distribution values, but also allows the investigation of any desired interval ranges on the traversing axis. This technique, moreover, is more rapid by a multiple factor than rastering, thereby allowing the material expenditure to be reduced at constant flow rates.

### Device (1)

Preferably, the device (1) is a measurement chamber and further contains a shielding unit (8) for collecting the sprayed coating material composition. More preferably, said measurement chamber is non-movable. In this case the device (1) is preferably an independent spray profiler.

Alternatively and also preferably, the at least one rotational atomizer (2), the at least one supply unit (4), the least one camera (5) and the at least one optical measurement unit (6) of the device (1) are positioned on a mobile rack (11) such that at least part of the device (1) is movable. Preferably, the device (1) as such in total is movable. In particular, such a device (1) is positioned within a spray booth or spray station or is positioned in front of a spray booth or spray station.

Preferably, the inventive device (1) further comprises at least one control unit (10). Particularly, the control unit (10) allows control of the atomizer (2), the at least one camera (5) and the at least one optical measurement unit (6).

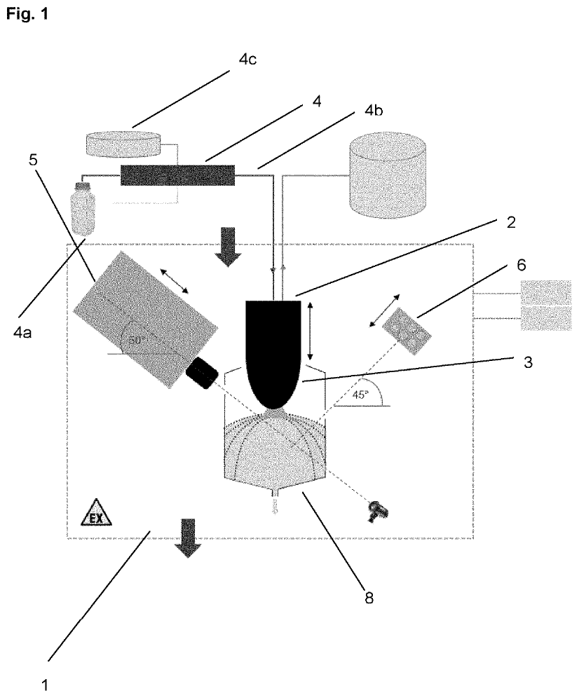

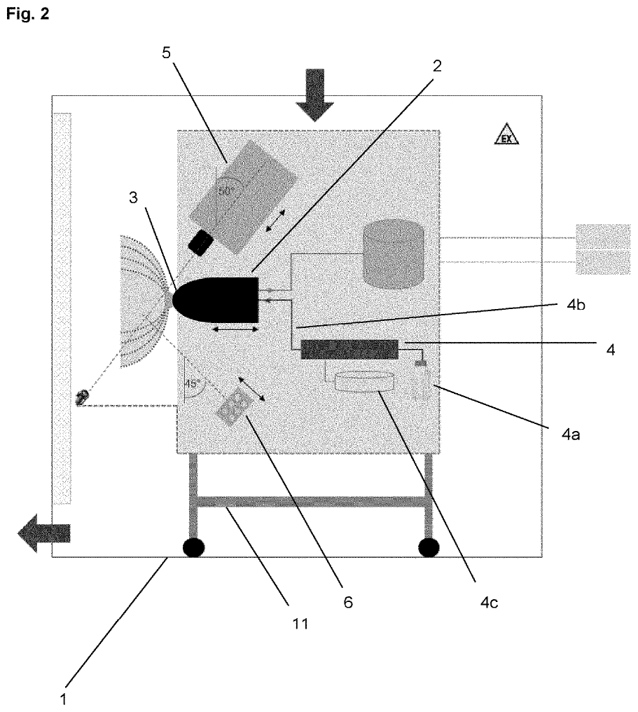

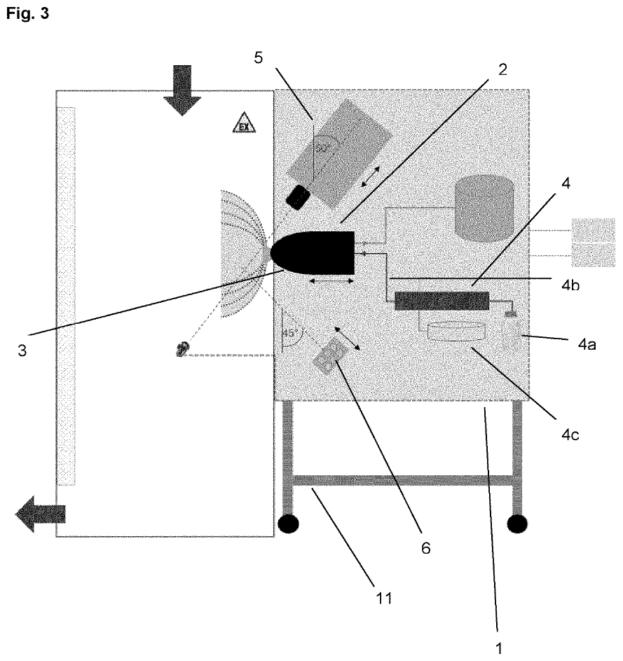

Exemplary embodiments of the inventive device (1) are illustrated in FIG. 1, FIG. 2 and FIG. 3.

The inventive device (1) according to FIG. 1 is in the form of a measurement chamber. Preferably, said measurement chamber is non-movable. In this case the device (1) is preferably an independent spray profiler. The device (1) contains a rotational atomizer (2), which comprises as application element a mountable bell cup (3) capable of rotation, at least one supply unit (4) for supplying a coating material composition to the rotational atomizer (2), at least one camera (5) for optical capturing of filaments formed by atomization of the coating material composition at the edge of the bell cup (3) and at least one optical measurement unit (6) for optical capturing of drops of a spray, which is formed by atomization of the coating material composition, by a traversing optical measurement through the entire spray. The device (1) further contains a shielding unit (8) for collecting the sprayed coating material composition. The paint supply unit (4) comprises at least one container (4a) comprising the coating material composition, at least one container (4c) comprising a solvent and means (4b) for supplying. Container (4c) is used to rinse the paint supply after atomization. Preferably, the inventive device (1) according to FIG. 1 further comprises a supply air unit for providing air into the chamber as well as an exhaust air unit.

The inventive device (1) according to FIG. 2 and FIG. 3 is at least partially positioned on a mobile rack (11) and is positioned within a spray booth or spray station (FIG. 2) or is positioned in front of a spray booth or spray station (FIG. 3). Positioned on the mobile rack (11) are rotational atomizer (2), which comprises as application element a mountable bell cup (3) capable of rotation, at supply unit (4) for supplying a coating material composition to the rotational atomizer (2), camera (5) and optical measurement unit (6). The paint supply unit (4) comprises at least one container (4a) comprising the coating material composition, at least one container (4c) comprising a solvent and means (4b) for supplying. Container (4c) is used to rinse the paint supply after atomization.

### Inventive Use

A further subject-matter of the present invention is a use of the inventive device (1) for optically monitoring a rotational atomization of a coating material composition. The inventive device (1) can, of course, additionally be used for performing said rotational atomization.

Further, the inventive device (1) is preferably also used for determining the mean length of filaments formed on rotational atomization of the coating material composition and/or for determining at least one characteristic variable of the drop size distribution within a spray and/or the homogeneity of said spray, the spray being formed on rotational atomization of the coating material composition.

All preferred embodiments described hereinbefore in connection with the inventive device (1) are also preferred embodiments in relation to the inventive use of the device (1).

### Inventive Method

A further subject-matter of the present invention is a method for determining the mean length of filaments formed on the edge of the bell cup of an rotational atomizer during rotational atomization of a coating material composition and/or for determining at least one characteristic variable of the drop size distribution within a spray and/or the homogeneity of said spray, the spray being formed on rotational atomization of a coating material composition, characterized in that the method is carried out by making use of the inventive device (1).

All preferred embodiments described hereinbefore in connection with the inventive device (1) and the inventive use thereof, are also preferred embodiments in relation to the inventive method.

Preferably, the inventive method is a method for simultaneously determining the mean length of filaments formed on the edge of the bell cup of an rotational atomizer during rotational atomization of a coating material composition and at least one characteristic variable of the drop size distribution within the spray and/or the homogeneity of said spray. However, it is also possible that the inventive method can be used for determining the mean length of filaments and the at least one characteristic variable of the drop size distribution/homogeneity of the spray one after another. No particular order is in this case needed.

The homogeneity of the spray in the sense of the present invention corresponds to the ratio of two quotients T_{T1}/T_{Total1} and T_{T2}/T_{Total2} to one another as a measure of the local distribution of transparent and nontransparent drops at two different positions within the spray, with T_{T1} corresponding to the number of transparent drops at the first position 1, T_{T2} corresponding to the number of transparent drops at the second position 2, T_{Total1} corresponding to the number of all drops of the spray and hence to the sum total of transparent drops and nontransparent drops at position 1, and T_{Total2} corresponding to the number of all drops of the spray and hence to the sum total of transparent drops and nontransparent drops at position 2, with position 1 being nearer to the center of the spray than position 2. Position 1, which is closer to the center of the spray than position 2, preferably represents an area segment within the spray that is different from position 2. Position 1—being located closer to the center of the spray than position 2—is located further in the interior of the spray than position 2, which, correspondingly, is located further outward in the spray, and at any rate further outward than position 1. If the spray is imagined in the form of a cone, position 1 is located further in the cone interior than position 2. Both positions 1 and 2, preferably lie on a measurement axis which leads through the entire spray. The distance between the two positions 1 and 2 within the spray, based on the overall length of the part of the measurement axis that is located within the spray and that corresponds to a figure of 100%, is preferably at least 10%, more preferably at least 15%, very preferably at least 20%, and more particularly at least 25% of this length of the measurement axis.

The determination, in accordance with the invention, of the size distribution of the drops formed by the atomization entails the determination of at least one characteristic variable known to the skilled person, such as suitable average diameters of the drops, such as, in particular, the D₁₀ (arithmetic diameter; “1.0” moment), D₃₀ (volume-equivalent average diameter; “3.0” moment), D₃₂ (Sauter diameter (SMD); “3.2” moment), d_{N,50%} (number-based median) and/or d_{V,50%} (volume-based median). The determination of the drop size distribution here encompasses the determination of at least one such characteristic variable, more particularly a determination of the D₁₀ of the drops. The aforesaid characteristic variables are in each case the corresponding numerical mean of the drop size distribution. The moments of the distributions are labeled here using the upper-case letter “D”; the index specifies the corresponding moment. The characteristic variables labeled with the lower-case letter “d” here are the percentiles (10%, 50%, 90%) of the corresponding cumulative distribution curve, with the 50% percentile corresponding to the median. The index “N” pertains to the number-based distribution, the index “V” to the volume-based distribution. As a further example of the aforementioned at least one characteristic variable, the drop velocity is to be named, which can also be measured by the inventive device (1).

More preferably, the inventive method is a method, which comprises at least the following steps (Ia), (IIa) and (IIIa) and/or (Ib), (IIb) and (IIIb):

(Ia) atomization of the coating material composition by means of the rotational atomizer (2) of the device (1),
(IIa) optical capture of the filaments formed on atomization as per step (Ia) at the edge of the bell cup (3), by means of the at least one camera (5), and
(IIIa) digital evaluation of the optical data obtained by the optical capture as per step (IIa), to give the mean length of those filaments formed on atomization that are located at the edge of the bell cup (3)
and/or
(Ib) atomization of the coating material composition by means of the rotational atomizer (2) of the device (1), the atomization producing a spray,
(IIb) optical capture of the drops of the spray formed by atomization as per step (Ib), by a traversing optical measurement through the entire spray, by means of the at least one optical measurement unit (6) and
(IIIb) determination of at least one characteristic variable of the drop size distribution within the spray and/or of the homogeneity of the spray, on the basis of optical data obtained by the optical capture as per step (IIb).

Preferably, steps (Ia), (IIa) and (IIIa) on the one hand as well as steps (Ib), (IIb) and (IIIb) on the other hand are performed in the inventive method. More preferably, the two series of steps are performed simultaneously. In particular, both step (Ia) and step (Ib) are performed simultaneously, and/or both step (IIa) and step (IIb) are performed simultaneously, and/or both step (IIIa) and step (IIIb) are performed simultaneously. Alternatively, however, the two series of steps can be performed one after another. In this case no particular order is needed.

### Steps (Ia), (IIa) and (IIIa)

Step (Ia) is an atomization of the coating material composition by means of the rotational atomizer (2) of the device (1). Step (IIa) of the method of the invention sees the filaments formed on atomization as per step (Ia) at the bell cup edge being captured optically by means of at least one camera (5).

Step (IIIa) of the method of the invention provides for a digital evaluation of the optical data obtained by the optical capture as per step (IIa). The aim of this digital evaluation is to determine the mean length of those filaments formed directly on the bell cup margin during the atomization, namely at the bell cup edge.

The digital evaluation as per step (IIIa) may be accomplished by means of image analysis and/or video analysis of the optical data obtained as per step (IIa), such as the images and/or videos recorded by the camera (5) within step (IIa).

Step (IIIa) is preferably carried out with support from software such as a MATLAB® software based on a MATLAB® code.

The digital evaluation as per step (IIIa) preferably encompasses two or more stages of an image and/or video processing of the optical data obtained as per step (IIa). Preferably at least 1000 images, more preferably at least 1500 images, very preferably at least 2000 images, of the images recorded in step (IIa) are used as the optical data basis for the digital evaluation as per step (IIIa).

The ascertainment of the mean filament length as per step (IIIa) preferably includes the standard deviations of the mean filament lengths.

Step (IIIa) is preferably carried out in multiple stages.

The digital evaluation as per step (IIIa) takes place preferably in at least six stages (3a) to (3f), specifically

(3a) smoothing of the images obtained as optical data after implementation of step (2), by means of a Gaussian filter, to remove the bell cup from the images,
(3b) binarization and inverting of the images smoothed as per stage (3a),
(3c) binarization of the images used in stage (3a) and addition of the images thus binarized to the inverted images from stage (3b), to give binarized images without bell cup edge, and inverting of the images thus obtained,
(3d) removal of drops, fragmented filaments, and filaments not located at the bell cup edge from the images obtained as per stage (3c), to give images on which all of the located objects remaining are filaments,
(3e) removal, from the images obtained as per stage (3d), of those filaments not located entirely within the images, and
(3f) tapering of all filaments remaining in the images after stage (3e) to their number of pixels, addition of the number of pixels for each of the filaments, determination of the filament length of each of the filaments on the basis of the pixel size, and ascertainment of the mean filament length for the entirety of all filaments measured.

The removal as per stage (3d) is preferably accomplished by (i) determination of the length of all hypotenuses of all objects located on the images, (ii) labeling of objects as drops and/or fragmented filaments on the images if the hypotenuse values ascertained for these objects fall below a defined value h, and elimination of these objects, and (iii) verification of the remaining objects, namely the filaments, on the basis of their position on the images, as to whether they were located at the bell cup edge, and elimination of those filaments to which this does not apply. The value h here corresponds to 15 pixels (or 300 μm).

The individual stages are elucidated in more detail below.

In a first stage (3a), the bell cup is preferably removed within the respective images recorded and used as the basis for the digital evaluation. For this purpose, a Gaussian filter is used to smooth each image to such an extent that the entire bell cup, more particularly the entire bell, is no longer visible.

In a second stage (3b), the images thus smoothed are preferably binarized and inverted.

In a third stage (3c), the original images as well, i.e. the images used in stage (3a), are preferably binarized and are added together with the inverted images from stage (3b). As a result, a binarized series of images is obtained, without bell edge, and this series of images is in turn preferably inverted for further evaluation.

The binarization takes place in each case in particular in order to more effectively distinguish the filaments for measurement from the background of the pictures.

In a fourth stage (3d), conditions are preferably defined by which filaments can be distinguished from other objects such as drops. Here, first of all, preferably the hypotenuses of all the objects in the respective pictures, including the filaments, are determined, being calculated by means of xₘᵢₙ, xₘₐₓ, yₘᵢₙ, and yₘₐₓ of the objects. The values are obtained by means of a MATLAB function which reports these extreme values, thus for each object the corresponding x value in the x-direction, namely xₘᵢₙ and xₘₐₓ, and for each object the corresponding y value in the y-direction, namely yₘᵢₙ and yₘₐₓ. The hypotenuses of the objects must be greater than a particular value h for the object thereof to be seen as being a filament. The value h here corresponds to pixels (or 300 μm). Consequently, all smaller objects, such as drops, are no longer considered for the ongoing evaluation. Moreover, each object must have a y value which is located in the immediate vicinity of the bell edge (which has already been removed on the images). The y value here corresponds to a value which is located over a defined distance in the y-direction on which each object must reside in order to be deemed to be a filament located at the bell edge. The concept of the “immediate vicinity” in this context comprehends y values which have a distance of not more than 5 pixels from the bell edge and/or a location of at most 5 pixels below the bell edge. Accordingly, all fragments, in particular all relatively long fragments, that are not connected to the bell cup edge are ruled out for the evaluation of the determination of the filament length, and the only filaments considered are those which are located at the bell cup edge.

In a fifth stage (3e), all objects still remaining within the respective pictures after implementation of stage (3d) are preferably verified as to whether their minimum x value is greater than 0 and their maximum x value is less than 256. Only objects meeting this condition are considered in the further course. Hence the only filaments evaluated are those which are located completely within the recorded image frame. All remaining objects in a picture are preferably numbered.

In a sixth stage (3f), all of the objects remaining after stage (3e) are preferably called up individually and tapered preferably by means of the skeleton method. This method is known to the skilled person. As a result, only one pixel of each object is then connected to at most one other pixel. Subsequently, the number of pixels per object or filament is counted together. Because the pixel size is known, the actual length of the filaments can be calculated. This image evaluation evaluates approximately 15 000 filaments per picture. This ensures a high statistical base in the determination of the filament lengths. From the entirety of all filament lengths thus ascertained for the filaments investigated, the mean length of these filaments is then obtained as a result. In this way, the mean length is obtained for those filaments formed on atomization that are located at the bell cup edge of the bell cup.

The method of the invention comprises at least steps (Ia), (IIa) and (IIIa)—in one alternative thereof—but may optionally also include further steps. Steps (Ia), (IIa) and (IIIa) are preferably carried out in numerical order.

### Steps (Ib), (IIb) and (IIIb)

Step (Ib) is an atomization of the coating material composition by means of the rotational atomizer (2) of the device (1), the atomization producing a spray. Step (IIb) is an optical capturing of the drops of the spray formed by atomization as per step (Ib), by a traversing optical measurement through the entire spray, by means of the at least one optical measurement unit (6).

The traversing optical measurement as per step (IIb) may be carried out at different traversing speeds. This speed may be linear or nonlinear. Through the choice of the traversing speed it is possible to simplify the area weighting: for instance, an increase in the traversing speed with increase of the area segments fulfills this purpose, and so the product of area and residence time is constant. The traversing speed is preferably selected such as to obtain at least 10 000 counts per area segment of the spray. The term “counts” in this context refers to the number of drops detected in the measurement within the spray or within different area segments of the spray. In case of the time-shift technique (TS) it can be further differentiated in counts for transparent drops and counts for non-transparent drops. The area segments represent positions within the spray.

The optical capture as per step (IIb) of the method of the invention takes place preferably by means of phase Doppler anemometry (PDA) and/or by means of the time-shift technique (TS). From the optical data obtained when carrying out step (IIb) by means of PDA, it is possible in step (IIIb) to determine at least one characteristic variable of the drop size distribution. From the optical data obtained when carrying out step (IIb) by means of TS, it is possible in step (IIIb) to determine both at least one characteristic variable of the drop size distribution and the homogeneity of the spray.

The optical capturing of step (IIb) takes place preferably on a measurement axis which is traversed repeatedly. The repetition is preferably 1 to 5 times, and more preferably it takes place at least 5 times. With particular preference the measurement takes place with at least 10 000 counts per measurement and/or at least 10 000 counts per area segment within the spray. Duplication measurement of the individual events is prevented preferably by an evaluation facility contained within the system.

Step (IIb) may be carried out at different tilt angles of the atomizer (2) relative to the measuring facility carrying out the measurement as per step (IIb). Accordingly it is possible to vary the tilt angle from 0 to 90°.

Step (IIIb) of the method of the invention envisions the determination of at least one characteristic variable of the drop size distribution within the spray and/or the homogeneity of the spray on the basis of optical data obtained by virtue of the optical capture as per step (IIb).

As already mentioned above, the determination of the drop size distribution of the drops formed by the atomization as per step (Ib), in accordance with the invention, preferably entails the determination of corresponding characteristic variables known to the skilled person, such as the D₁₀ (arithmetic diameter; “1.0” moment), D₃₀ (volume-equivalent average diameter “3.0” moment), D₃₂ (Sauter diameter (SMD); “3.2” moment), d_{N,50%} (number-based median) and/or d_{V,50%} (volume-based median), with at least one of these characteristic variables of the drop size distribution being determined within step (IIIb). In particular, the determination of the drop size distribution encompasses a determination of the D₁₀ of the drops. This is done in particular if step (IIb) is carried out by means of PDA and/or TS.

If step (IIb) is carried out by means of PDA, the optical data obtained after implementation of step (IIb) are preferably evaluated via an algorithm for any desired tolerances within step (IIIb). A tolerance of around 10% for the PDA system used limits the validation to spherical drops; an increase also brings slightly deformed drops into the assessment. As a result, it becomes possible to assess the sphericity of the measured drops along the measurement axis.

If step (IIb) is carried out by means of TS, the optical data obtained after implementation of step (IIb) are preferably likewise evaluated via an algorithm for any desired tolerances.

The homogeneity of the spray may be determined in particular if TS is used when carrying out step (IIb). The data obtained by means of TS as per implementation of step (IIb) can therefore be evaluated for the transparent spectrum (T) and for the nontransparent spectrum (NT) of the drops. The ratio of the number of measured drops in both spectra serves as a measure of the local distribution of transparent and nontransparent drops. An integral assessment along the measurement axis is possible. Specifically, the ratio of the transparent drops (T) to the total number of drops (Total) is determined preferably at a position of x=5 mm or x=25 mm along the measurement axis. These positions then correspond to the aforesaid positions 1 (x=5 mm) and 2 (x=25 mm). A ratio is formed in turn from the corresponding values, in order to describe the spray jet homogeneity, which changes from the inside outward.

### Inventively Used Coating Material Compositions

The coating material composition used in accordance with the invention preferably comprises
at least one polymer employable as binder, as component (a),
at least one pigment and/or at least one filler as component (b), and
water and/or at least one organic solvent as component (c).

The term “comprising” or “embracing” in the sense of the present invention, especially in connection with the coating material composition used in accordance with the invention, preferably has the meaning of “consisting of”. With regard to the coating material composition used in accordance with the invention, for example, it may comprise not only components (a), (b), and (c) but also one or more of the other, optional components identified hereinafter. All these components may each be present in their preferred embodiments as stated below.

The coating material composition used in accordance with the invention is preferably a coating material composition which is employable in the automobile industry. Here it is possible to use coating material compositions which can be employed as part of an OEM paint system, and those which can be employed as part of a refinish system. Examples of coating material compositions employable in the automobile industry are electrocoat materials, primers, surfacers, fillers, basecoat materials, especially waterborne basecoat materials (aqueous basecoat materials), topcoat materials, including clearcoat materials, especially solventborne clearcoat materials. The use of waterborne basecoat materials is particularly preferred.

The concept of the basecoat material is known to the skilled person and defined for example in Römpp Lexikon, Lacke und Druckfarben, Georg Thieme Verlag, 1998, 10^{th} edition, page 57. A basecoat material, accordingly, is more particularly an interim coating material which imparts color and/or imparts color and an optical effect, used in automotive finishing and general industry coating. It is applied in general to a surfacer-pretreated or primer-pretreated metal or plastics substrate, or occasionally directly to the plastics substrate. Other possible substrates include existing finishes, possibly further requiring pretreatment (by sanding, for example). It is now entirely customary for more than one basecoat to be applied. In such a case, accordingly, a first basecoat represents the substrate for a second basecoat. To protect a basecoat, particularly from environmental effects, at least one additional clearcoat is applied over it. A waterborne basecoat material is an aqueous basecoat material in which the fraction of water is >the fraction of organic solvents, based on the total weight of water and organic solvents in % by weight within the waterborne basecoat material.

The fractions in % by weight of all components present in the coating material composition used in accordance with the invention, such as components (a), (b), and (c), and optionally one or more of the further, optional components identified hereinafter, add up to 100% by weight, based on the total weight of the coating material composition.

The solids content of the coating material composition used in accordance with the invention is preferably in a range from 10 to 45% by weight, more preferably from 11 to 42.5% by weight, very preferably from 12 to 40% by weight, more particularly from 13 to 37.5% by weight, based in each case on the total weight of the coating material composition. The solids content, i.e., the nonvolatile fraction, is determined as per the method described hereinafter.

### Component (a)

The term “binder” refers in the sense of the present invention and in agreement with DIN EN ISO 4618 (German version, date: March 2007) preferably to the nonvolatile fractions—those responsible for forming the film—of a composition such as the coating material composition employed in accordance with the invention, with the exception of the pigments and/or fillers it contains. The nonvolatile fraction may be determined according to the method described hereinafter. A binder constituent, accordingly, is any component which contributes to the binder content of a composition such as the coating material composition used in accordance with the invention. An example would be a basecoat material, such as an aqueous basecoat material, which comprises at least one polymer employable as binder as component (a), such as, for example, a below-described SCS polymer; a crosslinking agent such as a melamine resin; and/or a polymeric additive.

Particularly preferred for use as component (a) is what is called a seed-core-shell polymer (SCS polymer). Such polymers, and aqueous dispersions comprising such polymers, are known from WO 2016/116299 A1, for example. The polymer is preferably a (meth)acrylic copolymer. The polymer is used preferably in the form of an aqueous dispersion. Especially preferred for use as component (a) is a polymer having an average particle size in the range from 100 to 500 nm, preparable by successive radical emulsion polymerization of three monomer mixtures (A), (B), and (C), preferably different from one another, of olefinically unsaturated monomers in water, where

the mixture (A) comprises at least 50% by weight of monomers having a solubility in water of less than 0.5 g/l at 25° C., and a polymer prepared from the mixture (A) possesses a glass transition temperature of 10 to 65° C., the mixture (B) comprises at least one polyunsaturated monomer, and a polymer prepared from the mixture (B) possesses a glass transition temperature of −35 to 15° C., and
a polymer prepared from the mixture (C) possesses a glass transition temperature of −50 to 15° C.,
and wherein
i. first the mixture (A) is polymerized,
ii. then the mixture (B) is polymerized in the presence of the polymer prepared under i., and
iii. thereafter the mixture (C) is polymerized in the presence of the polymer prepared under ii.

The preparation of the polymer comprises the successive radical emulsion polymerization of three mixtures (A), (B), and (C) of olefinically unsaturated monomers in each case in water. It is therefore a multistage radical emulsion polymerization where i. first the mixture (A) is polymerized, then ii. the mixture (B) is polymerized in the presence of the polymer prepared under i. and, furthermore, iii. the mixture (C) is polymerized in the presence of the polymer prepared under ii. All three monomer mixtures are therefore polymerized by a radical emulsion polymerization (i.e. stage or else polymerization stage), carried out separately in each case, with these stages taking place successively. In terms of time, the stages may take place immediately after one another. It is equally possible, after the end of one stage, for the reaction solution in question to be stored for a certain period and/or transferred to a different reaction vessel, and only then for the next stage to be carried out. The preparation of the polymer preferably comprises no polymerization steps other than the polymerization of the monomer mixtures (A), (B), and (C).

The mixtures (A), (B), and (C) are mixtures of olefinically unsaturated monomers. Suitable olefinically unsaturated monomers may be mono- or polyolefinically unsaturated. Examples of suitable monoolefinically unsaturated monomers include, in particular, (meth)acrylate-based monoolefinically unsaturated monomers, monoolefinically unsaturated monomers containing allyl groups, and other monoolefinically unsaturated monomers containing vinyl groups, such as vinylaromatic monomers, for example. The term (meth)acrylic or (meth)acrylate for the purposes of the present invention encompasses both methacrylates and acrylates. Preferred for use at any rate, though not necessarily exclusively, are (meth)acrylate-based monoolefinically unsaturated monomers.

The mixture (A) comprises at least 50% by weight, and preferably at least 55% by weight, of olefinically unsaturated monomers having a water solubility of less than 0.5 g/l at 25° C. One such preferred monomer is styrene. The solubility of the monomers in water is determined by means of the method described hereinafter. The monomer mixture (A) preferably contains no hydroxy-functional monomers. Likewise preferably, the monomer mixture (A) contains no acid-functional monomers. Very preferably the monomer mixture (A) contains no monomers at all that have functional groups containing heteroatoms. This means that heteroatoms, if present, are present only in the form of bridging groups. This is the case, for example, in the (meth)acrylate-based monoolefinically unsaturated monomers described above that possess an alkyl radical as radical R. The monomer mixture (A) preferably comprises exclusively monoolefinically unsaturated monomers. The monomer mixture (A) preferably comprises at least one monounsaturated ester of (meth)acrylic acid with an alkyl radical, and at least one monoolefinically unsaturated monomer containing vinyl groups and having, disposed on the vinyl group, a radical which is aromatic or that is mixed saturated aliphatic-aromatic, in which case the aliphatic fractions of the radical are alkyl groups. The monomers present in the mixture (A) are selected such that a polymer prepared from them possesses a glass transition temperature of 10 to 65° C., preferably of 30 to 50° C. The glass transition temperature here can be determined by means of the method described hereinafter. The polymer prepared in stage i. by the emulsion polymerization of the monomer mixture (A) is also called seed. The seed possesses preferably an average particle size of 20 to 125 nm.

The mixture (B) comprises at least one polyolefinically unsaturated monomer, preferably at least one diolefinically unsaturated monomer. A corresponding preferred monomer is hexanediol diacrylate. The monomer mixture (B) preferably contains no hydroxy-functional monomers. Likewise preferably, the monomer mixture (B) contains no acid-functional monomers. Very preferably, the monomer mixture (B) contains no monomers at all that have functional groups containing heteroatoms. This means that heteroatoms, if present, are present only in the form of bridging groups. This is the case, for example, in the above-described (meth)acrylate-based, monoolefinically unsaturated monomers possessing an alkyl radical as radical R. Besides the at least one polyolefinically unsaturated monomer, the monomer mixture (B) preferably at any rate includes the following monomers: firstly, at least one monounsaturated ester of (meth)acrylic acid with an alkyl radical, and secondly at least one monoolefinically unsaturated monomer containing vinyl groups and having, arranged on the vinyl group, a radical which is aromatic or which is mixed saturated aliphatic-aromatic, in which case the aliphatic fractions of the radical are alkyl groups. The proportion of polyunsaturated monomers is preferably from 0.05 to 3 mol %, based on the total molar amount of monomers in the monomer mixture (B). The monomers present in the mixture (B) are selected such that a polymer prepared therefrom possesses a glass transition temperature of −35 to 15° C., preferably from −25 to +7° C. The polymer prepared in the presence of the seed in stage ii. by the emulsion polymerization of the monomer mixture (B) is also referred to as the core. After stage ii., therefore, the resultant polymer comprises seed and core. The polymer which is obtained after stage ii. preferably possesses an average particle size of 80 to 280 nm, preferably 120 to 250 nm.

The monomers present in the mixture (C) are selected such that a polymer prepared therefrom possesses a glass transition temperature of −50 to 15° C., preferably of −20 to +12° C. This glass transition temperature may be determined by the method described hereinafter. The olefinically unsaturated monomers of the mixture (C) are preferably selected such that the resultant polymer, comprising seed, core, and shell, has an acid number of 10 to 25. Accordingly, the mixture (C) preferably comprises at least one alpha-beta unsaturated carboxylic acid, especially preferably (meth)acrylic acid. The olefinically unsaturated monomers in the mixture (C) are preferably selected, additionally or alternatively, in such a way that the resulting polymer, comprising seed, core, and shell, has an OH number of 0 to 30, preferably 10 to 25. All of the aforementioned acid numbers and OH numbers are values calculated on the basis of the entirety of monomer mixtures employed. The monomer mixture (C) preferably comprises at least one alpha-beta unsaturated carboxylic acid and at least one monounsaturated ester of (meth)acrylic acid with an alkyl radical substituted by a hydroxyl group. With particular preference the monomer mixture (C) comprises at least one alpha-beta unsaturated carboxylic acid, at least one monounsaturated ester of (meth)acrylic acid having an alkyl radical substituted by a hydroxyl group, and at least one monounsaturated ester of (meth)acrylic acid with an alkyl radical. Where the present invention refers to an alkyl radical without further particularization, the reference is always to a pure alkyl radical without functional groups and heteroatoms. The polymer prepared in stage iii. by the emulsion polymerization of the monomer mixture (C) in the presence of seed and core is also referred to as the shell. The result after stage iii., therefore, is a polymer which comprises seed, core, and shell, in other words polymer (b). After its preparation, the polymer (b) possesses an average particle size of 100 to 500 nm, preferably 125 to 400 nm, very preferably of 130 to 300 nm.

The coating material composition used in accordance with the invention preferably comprises a fraction of component (a) such as at least one SCS polymer in a range from 1.0 to 20% by weight, more preferably from 1.5 to 19% by weight, very preferably from 2.0 to 18.0% by weight, more particularly from 2.5 to 17.5% by weight, most preferably from 3.0 to 15.0% by weight, based in each case on the total weight of the coating material composition. The determination and specification of the fraction of component (a) within the coating material composition may be made via the determination of the solids content (also called nonvolatile fraction, solids content, or solids fraction) of an aqueous dispersion comprising component (a).

Additionally or alternatively, preferably additionally, to the at least one above-described SCS polymer as component (a), the coating material composition used in accordance with the invention may comprise at least one polymer different from the SCS polymer, as binder of component (a), more particularly at least one polymer selected from the group consisting of polyurethanes, polyureas, polyesters, poly(meth)acrylates and/or copolymers of the stated polymers, more particularly polyurethane-poly(meth)acrylates and/or polyurethane-polyureas.

Preferred polyurethanes are described for example in German patent application DE 199 48 004 A1, page 4, line 19 to page 11, line 29 (polyurethane prepolymer B1), in European patent application EP 0 228 003 A1, page 3, line 24 to page 5, line 40, in European patent application EP 0 634 431 A1, page 3, line 38 to page 8, line 9, and in international patent application WO 92/15405, page 2, line 35 to page 10, line 32.

Preferred polyesters are described for example in DE 4009858 A1 in column 6, line 53 to column 7, line 61 and column 10, line 24 to column 13, line 3, or WO 2014/033135 A2, page 2, line 24 to page 7, line 10 and also page 28, line 13 to page 29, line 13.

Preferred polyurethane-poly(meth)acrylate copolymers ((meth)acrylated polyurethanes) and their preparation are described for example in WO 91/15528 A1, page 3, line 21 to page 20, line 33 and also in DE 4437535 A1, page 2, line 27 to page 6, line 22.

Preferred polyurethane-polyurea copolymers are polyurethane-polyurea particles, preferably those having an average particle size of 40 to 2000 nm, where the polyurethane-polyurea particles, in each case in reacted form, comprise at least one polyurethane prepolymer containing isocyanate groups and comprising anionic groups and/or groups which can be converted into anionic groups, and also at least one polyamine containing two primary amino groups and one or two secondary amino groups. Such copolymers are used preferably in the form of an aqueous dispersion. Polymers of these kinds are preparable in principle by conventional polyaddition of, for example, polyisocyanates with polyols and also polyamines.

The fraction in the coating material composition of such polymers different from the SCS polymer is preferably smaller than the fraction of the SCS polymer. The polymers described are preferably hydroxy-functional and especially preferably possess an OH number in the range from 15 to 200 mg KOH/g, more preferably of 20 to 150 mg KOH/g.

With particular preference the coating material compositions used in accordance with the invention comprise at least one hydroxy-functional polyurethane-poly(meth)acrylate copolymer; with further preference they comprise at least one hydroxy-functional polyurethane-poly(meth)acrylate copolymer and also at least one hydroxy-functional polyester and also, optionally, a preferably hydroxy-functional polyurethane-polyurea copolymer.

The fraction of the further polymers as binders of component (a)—additionally to an SCS polymer—may vary widely and is preferably in the range from 1.0 to 25.0% by weight, more preferably 3.0 to 20.0% by weight, very preferably 5.0 to 15.0% by weight, based in each case on the total weight of the coating material composition.

The coating material composition may further comprise at least one conventional, typical crosslinking agent. If it comprises a crosslinking agent, the species in question is preferably at least one amino resin and/or at least one blocked or free polyisocyanate, preferably an amino resin. Among the amino resins, melamine resins in particular are preferred. Where the coating material composition includes crosslinking agents, the fraction of these crosslinking agents, more particularly amino resins and/or blocked or free polyisocyanates, more preferably amino resins, in turn preferably melamine resins, is preferably in the range from 0.5 to 20.0% by weight, more preferably 1.0 to 15.0% by weight, very preferably 1.5 to 10.0% by weight, based in each case on the total weight of the coating material composition. The fraction of crosslinking agent is preferably smaller than the fraction of the SCS polymer in the coating material composition.

### Component (b)

A skilled person is familiar with the terms “pigments” and “fillers”.

The term ‘Tiller’ is known to the skilled person from DIN 55943 (date: October 2001), for example. A “filler” in the sense of the present invention is preferably a component which is substantially, preferably completely, insoluble in the coating material composition used in accordance with the invention, such as a waterborne basecoat material, for example, and which is used in particular for the purpose of increasing the volume. “Fillers” in the sense of the present invention are preferably different from “pigments” in their refractive index, which for fillers is <1.7. Any customary filler known to the skilled person may be used as component (b). Examples of suitable fillers are kaolin, dolomite, calcite, chalk, calcium sulfate, barium sulfate, graphite, silicates such as magnesium silicates, especially corresponding phyllosilicates such as hectorite, bentonite, montmorillonite, talc and/or mica, silicas, especially fumed silicas, hydroxides such as aluminum hydroxide or magnesium hydroxide, or organic fillers such as textile fibers, cellulose fibers, polyethylene fibers or polymer powders.

The term “pigment” is likewise known to the skilled person, from DIN 55943 (date: October 2001), for example. A “pigment” in the sense of the present invention refers preferably to components in powder or platelet form which are substantially, preferably entirely, insoluble in the coating material composition used in accordance with the invention, such as a waterborne basecoat material, for example. These “pigments” are preferably colorants and/or substances which can be used as pigment by virtue of their magnetic, electrical and/or electromagnetic properties. Pigments differ from “fillers” preferably in their refractive index, which for pigments is ≥1.7.

The term “pigments” preferably subsumes color pigments and effect pigments.

A skilled person is familiar with the concept of color pigments. For the purposes of the present invention, the terms “color-imparting pigment” and “color pigment” are interchangeable. A corresponding definition of the pigments and further specifications thereof are dealt with in DIN 55943 (date: October 2001). Color pigment used may comprise organic and/or inorganic pigments. Particularly preferred color pigments used are white pigments, chromatic pigments and/or black pigments. Examples of white pigments are titanium dioxide, zinc white, zinc sulfide, and lithopones. Examples of black pigments are carbon black, iron manganese black, and spinel black. Examples of chromatic pigments are chromium oxide, chromium oxide hydrate green, cobalt green, ultramarine green, cobalt blue, ultramarine blue, manganese blue, ultramarine violet, cobalt and manganese violet, red iron oxide, cadmium sulfoselenide, molybdate red and ultramarine red, brown iron oxide, mixed brown, spinel phases and corundum phases, and chromium orange, yellow iron oxide, nickel titanium yellow, chromium titanium yellow, cadmium sulfide, cadmium zinc sulfide, chromium yellow, and bismuth vanadate.

A skilled person is familiar with the concept of effect pigments. A corresponding definition is found for example in Römpp Lexikon, Lacke und Druckfarben, Georg Thieme Verlag, 1998, 10 edition, pages 176 and 471. A definition of pigments in general and further specifications thereof are dealt with in DIN 55943 (date: October 2001). Effect pigments are preferably pigments which impart optical effect or color and optical effect, especially optical effect. The terms “optical effect-imparting and color-imparting pigment”, “optical effect pigment” and “effect pigment” are therefore preferably interchangeable. Preferred effect pigments are, for example, platelet-shaped metallic effect pigments such as leaflet-like aluminum pigments, gold bronzes, oxidized bronzes and/or iron oxide-aluminum pigments, pearlescent pigments such as pearl essence, basic lead carbonate, bismuth oxychloride and/or metal oxide-mica pigments and/or other effect pigments such as leaflet-like graphite, leaflet-like iron oxide, multilayer effect pigments from PVD films and/or liquid crystal polymer pigments. Particularly preferred are effect pigments in leaflet form, especially leaflet-like aluminum pigments and metal oxide-mica pigments.

The coating material composition used in accordance with the invention, such as a waterborne basecoat material, for example, with particular preference includes at least one effect pigment as component (b).

The coating material composition used in accordance with the invention preferably comprises a fraction of effect pigment as component (b) in a range from 1 to 20% by weight, more preferably from 1.5 to 18% by weight, very preferably from 2 to 16% by weight, more particularly from 2.5 to 15% by weight, most preferably from 3 to 12% by weight or from 3 to 10% by weight, based in each case on the total weight of the coating material composition. The total fraction of all pigments and/or fillers in the coating material composition is preferably in the range from 0.5 to 40.0% by weight, more preferably from 2.0 to 20.0% by weight, very preferably from 3.0 to 15.0% by weight, based in each case on the total weight of the coating material composition.

The relative weight ratio of component (b) such as at least one effect pigment to component (a) such as at least one SCS polymer in the coating material composition is preferably within a range from 4:1 to 1:4, more preferably in a range from 2:1 to 1:4, very preferably in a range from 2:1 to 1:3, more particularly in a range from 1:1 to 1:3 or from 1:1 to 1:2.5.

### Component (c)

The coating material composition used in accordance with the invention is preferably aqueous. It is preferably a system comprising as its solvent (i.e., as component (c)) primarily water, preferably in an amount of at least 20% by weight, and organic solvents in smaller fractions, preferably in an amount of <20% by weight, based in each case on the total weight of the coating material composition.

The coating material composition used in accordance with the invention preferably comprises a fraction of water of at least 20% by weight, more preferably of at least 25% by weight, very preferably of at least 30% by weight, more particularly of at least 35% by weight, based in each case on the total weight of the coating material composition.

The coating material composition used in accordance with the invention preferably comprises a fraction of water that is within a range from 20 to 65% by weight, more preferably in a range from 25 to 60% by weight, very preferably in a range from 30 to 55% by weight, based in each case on the total weight of the coating material composition.

The coating material composition used in accordance with the invention preferably comprises a fraction of organic solvents that is within a range of <20% by weight, more preferably in a range from 0 to <20% by weight, very preferably in a range from 0.5 to <20% by weight or to 15% by weight, based in each case on the total weight of the coating material composition.

Examples of such organic solvents include heterocyclic, aliphatic or aromatic hydrocarbons, mono- or polyhydric alcohols, especially methanol and/or ethanol, ethers, esters, ketones, and amides, such as N-methylpyrrolidone, N-ethylpyrrolidone, dimethylformamide, toluene, xylene, butanol, ethyl glycol and butyl glycol and also their acetates, butyl diglycol, diethylene glycol dimethyl ether, cyclohexanone, methyl ethyl ketone, methyl isobutyl ketone, acetone, isophorone, or mixtures thereof.

### Further Optional Components

The coating material composition used in accordance with the invention may optionally further comprise at least one thickener (also referred to as thickening agent) as component (d). Examples of such thickeners are inorganic thickeners, as for example metal silicates such as phyllosilicates, and organic thickeners, as for example poly(meth)acrylic acid thickeners and/or (meth)acrylic acid-(meth)acrylate copolymer thickeners, polyurethane thickeners, and also polymeric waxes. The metal silicate is selected preferably from the group of the smectites. The smectites are selected with particular preference from the group of the montmorillonites and hectorites. The montmorillonites and hectorites are selected more particularly from the group consisting of aluminum magnesium silicates and also sodium magnesium phyllosilicates and sodium magnesium fluorine lithium phyllosilicates. These inorganic phyllosilicates are sold under the brand name Laponite®, for example. Thickening agents based on poly(meth)acrylic acid and (meth)acrylic acid-(meth)acrylate copolymer thickeners are optionally crosslinked and/or neutralized with a suitable base. Examples of such thickening agents are “alkali swellable emulsions” (ASEs) and hydrophobically modified variants of them, the “hydrophobically modified alkali swellable emulsions” (HASE). These thickening agents are preferably anionic. Corresponding products such as Rheovis® AS 1130 are available commercially. Thickening agents based on polyurethanes (e.g., polyurethane associative thickening agents) are optionally crosslinked and/or neutralized with a suitable base. Corresponding products such as Rheovis® PU1250 are available commercially. Examples of suitable polymeric waxes include optionally modified polymeric waxes based on ethylene-vinyl acetate copolymers. A corresponding product is available commercially under the designation Aquatix® 8421, for example.

Depending on the desired application, the coating material composition used in accordance with the invention may comprise one or more commonly employed additives as further component or components (d). By way of example, the coating material composition may comprise at least one additive selected from the group consisting of reactive diluents, light stabilizers, antioxidants, deaerating agents, emulsifiers, slip additives, polymerization inhibitors, initiators for radical polymerizations, adhesion promoters, flow control agents, film-forming assistants, sag control agents (SCAs), flame retardants, corrosion inhibitors, siccatives, biocides, and flatting agents. They may be used in the known and customary proportions.

The coating material composition used in accordance with the invention may be produced using the customary and known mixing methods and mixing units.

### Determination Methods

### 1. Determination of the Mean Filament Length

The breakdown of the filaments at the bell edge is recorded by means of the high-speed camera Fastcam SA-Z (from Photron Tokyo, Japan) at an image rate of 100 000 images per second and at a resolution of 512×256 pixels. The camera represent camera (5) of the inventive device (1). Image analysis uses 2000 images per recording. First of all, the individual images are processed in a number of steps in order to be able to evaluate the length of the filaments. In the first process step, the bell edge is removed from the respective images. For this purpose, each image is smoothed by means of a Gaussian filter to an extent such that only the bell edge is still visible. These images are subsequently binarized and inverted (a). After that, the original images as well are binarized (b) and are added together with the inverted images (a). The result obtained is a binarized series of images without bell edge, and this series of images is inverted (c) for further evaluation. In the next step, conditions are defined so that filaments can be distinguished from other objects. First, the hypotenuses of all the objects are determined, being calculated by means of xₘᵢₙ, xₘₐₓ, yₘᵢₙ, and yₘₐₓ of the objects. The hypotenuses of the objects must be greater than a defined value h for the object thereof to be regarded as a filament. All smaller objects, such as drops, are no longer considered for the subsequent evaluation. Moreover, each object must have a y value which is located in the immediate vicinity of the bell edge. Accordingly, longer fragments, which are not joined to the bell edge, are excluded for the purposes of evaluating the filament length. Lastly, the remaining objects are required to meet the condition that their minimum x value is greater than 0 and their maximum x value is smaller than 256. Accordingly, the only filaments evaluated are those which are located entirely within the recorded image frame. All objects which are able to meet the four conditions are called up individually and tapered using the skeleton method. As a result, only one pixel of each object is connected at most to one other pixel. Subsequently, the number of pixels per filament is counted up. Because the pixel size is known, the actual length of the filaments can be calculated. This image analysis evaluates approximately 15 000 filaments per picture. This ensures a high statistical base for the determination of the filament lengths.

2. Determining the Particle Size Distribution Including the D₁₀ and Also the Ratio of the Characteristic Variables T_{T1}/T_{Total1} and T_{T2}/T_{Total2} as a Measurement of the Homogeneity of the Spray Arising from Atomization

The parent particle size distributions are determined using a commercial single PDA from DantecDynamics (P60, Lexel argon laser, FibreFlow) and also a commercial time-shift instrument from AOM Systems (SpraySpy®). Both instruments are constructed and aligned in accordance with the manufacturer information. The settings for the time-shift instrument SpraySpy® are adapted by the manufacturer for the range of materials to be used. The PDA is operated in forward scattering at an angle of 60-70° with a wavelength of 514.5 nm (orthogonally polarized) in reflection. The receiving optics here have a focal length of 500 mm, the transmitting optics a focal length of 400 mm. For both systems, the construction is aligned relative to the atomizer. Measurement is made traversingly in a radial-axial direction in relation to the tilted atomizer (tilt angle 45°), 25 mm vertically below the atomizer flank inclined to the traversing axis. In this case a defined traversing velocity is predetermined, and so spatial resolution of the individual events detected takes place via the associated time-resolved signals. A comparison to raster-resolved measurements yields identical results for the weighted global distribution characteristics, but also allows the investigation of any desired interval ranges on the traversing axis. Moreover, this method is faster by a multiple than rastering, thereby allowing a reduction in the expenditure on the material for constant flow rates. The detectable drops are captured with maximum validation tolerance. The raw data are then evaluated via an algorithm for any desired tolerances. A tolerance of around 10% for the PDA system used limits the validation to spherical particles; an increase also draws slightly deformed drops into the consideration. As a result, consideration of the sphericity of the measured drops along the measurement axis is made possible. The SpraySpy® system is capable of distinguishing between transparent and nontransparent drops. The measurement axis is traveled repeatedly and both measurement methods are employed. Duplicate measurements of the individual events are prevented by the system's internal analysis facility. The data thus obtained can therefore be evaluated for the transparent spectrum (T) and for the nontransparent spectrum (NT). The ratio of the number of measured drops in both spectra serves as a measure of the local distribution of transparent and nontransparent drops. An integral appraisal along the measurement axis is possible. Specifically, the ratio of the transparent particles (T) to the total number of particles (Total) is determined at a position 1 of x=5 mm and at a position 2 of x=25 mm along the measurement axis; a ratio is formed in turn from the corresponding values, in order to describe the changing homogeneity of the spray jet from inside to outside. For both systems, single PDA and SpraySpy®, the raw data can be used as a basis for determining customary distribution moments such as D₁₀ values, for example.

### 3. Determination of Film Thicknesses

The film thicknesses are determined in accordance with DIN EN ISO 2808 (date: May 2007), method 12A, using the MiniTest® 3100-4100 instrument from ElektroPhysik.

### 4. Assessment of the Incidence of Pinholes and the Film Thickness-Dependent Leveling

To assess the incidence of pinholes and the film thickness-dependent leveling, wedge-format multicoat paint systems are produced in accordance with the following general protocol:

A steel panel with dimensions of 30×50 cm, coated with a standard electrocoat (CathoGuard® 800 from BASF Coatings GmbH), is provided at one longitudinal edge with an adhesive strip (Tesaband, 19 mm) to allow determination of film thickness differences after coating. A waterborne basecoat material is applied electrostatically as a wedge with a target film thickness (film thickness of the dried material) of 0-40 μm. The discharge rate here is between 300 and 400 ml/min; the rotary speed of the ESTA bell is varied between 23 000 and 43 000 rpm; the exact figures for each of the application parameters specifically selected are stated below within the experimental section. After a flash-off time of 4-5 minutes at room temperature (18 to 23° C.), the system is dried in a forced air oven at 60° C. for 10 minutes. Following removal of the adhesive strip, a commercial two-component clearcoat material (ProGloss® from BASF Coatings GmbH) is applied by gravity-fed spray gun, manually, to the dried waterborne basecoat, with a target film thickness (film thickness of the dried material) of 40-45 μm. The resulting clearcoat is flashed off at room temperature (18 to 23° C.) for 10 minutes; this is followed by curing in a forced air oven at 140° C. for a further 20 minutes.

Incidence of pinholes is assessed visually according to the following general protocol: the dry film thickness of the waterborne basecoat material is checked, and, for the basecoat film thickness wedge, the ranges of 0-20 μm and also of 20 μm to the end of the wedge are marked on the steel panel. The pinholes are evaluated visually in the two separate regions of the waterborne basecoat wedge. The number of pinholes per region is counted. All results are standardized to an area of 200 cm² and then summed to give a total number. Additionally, where appropriate, a record is made of the dry film thickness of the waterborne basecoat wedge from which pinholes no longer occur.

The film thickness-dependent leveling is assessed according to the following general protocol: the dry film thickness of the waterborne basecoat material is checked, and, for the basecoat film thickness wedge, different regions, for example 10-15 μm, 15-20 μm, and 20-25 μm, are marked on the steel panel. The film thickness-dependent leveling is determined and assessed using the Wave scan instrument from Byk-Gardner GmbH, within the basecoat film thickness regions ascertained beforehand. For this purpose, a laser beam is directed at an angle of 60° onto the surface under investigation, and fluctuations in the reflected light in the short wave range (0.3 to 1.2 mm) and in the long wave range (1.2 to 12 mm) are recorded by the instrument over a distance of 10 cm (long wave=LW; short wave=SW; the lower the figures, the better the appearance). Furthermore, as a measure of the sharpness of an image reflected in the surface of the multicoat system, the characteristic parameter of “distinctness of image” (DOI) is determined with the aid of the instrument (the higher the value, the better the appearance).

### 5. Determination of Cloudiness

For determining the cloudiness, multicoat paint systems are produced according to the following general protocol:

A steel panel with dimensions 32×60 cm, coated with a conventional surfacer system, is further coated with a waterborne basecoat material by means of dual application: application in the first step is made electrostatically with a target film thickness of 8-9 μm, and in the second step, after a 2-minute flash-off time at room temperature, it is made likewise electrostatically with a target film thickness of 4-5 μm. After a further flash-off time at room temperature (18 to 23° C.) of 5 minutes, the resulting waterborne basecoat is dried in a forced air oven at 80° C. for 5 minutes. Both basecoat applications are made with a rotary speed of 43 000 rpm and a discharge rate of 300 ml/min. Applied atop the dried waterborne basecoat is a commercial two-component clearcoat material (ProGloss from BASF Coatings GmbH), with a target film thickness of 40-45 μm. The resulting clearcoat is flashed off at room temperature (18 to 23° C.) for 10 minutes; this is followed by curing in a forced air oven at 140° C. for a further 20 minutes.

The cloudiness is then assessed using the cloud-runner instrument from BYK-Gardner GmbH. The instruments output parameters including the three characteristic parameters of “mottling15”, “mottling45”, and “mottling60”, which can be seen as a measure of the cloudiness measured at the angles of 15°, 45°, and 60° relative to the reflection angle of the measurement light source used. The higher the value, the more pronounced the cloudiness.

### 6. Determination of Wetness

An assessment is made of the wetness of a film formed after application to a substrate of a coating material composition such as a waterborne basecoat material. The coating material composition in this case is applied electrostatically by means of rotational atomization as a constant layer in the desired target film thickness (film thickness of the dried material) such as a target film thickness within a range from 15 μm to 40 μm. The discharge rate is between 300 and 400 ml/min and the rotary speed of the ESTA bell of the rotary atomizer is in a range from 23 000 to 43 000 rpm (the precise details of the application parameters specifically selected in each case are stated at the relevant points hereinafter within the experimental section). A visual assessment of the wetness of the film formed on the substrate is made one minute after the end of application. The wetness is recorded on a scale from 1 to 5 (1=very dry to 5=very wet).

### 7. Determination of the Incidence of Pops

To determine the propensity toward popping, a multicoat paint system is produced in a method based on DIN EN ISO 28199-1 (date: January 2010) and DIN EN ISO 28199-3 (date: January 2010) in accordance with the following general protocol: a perforated steel plate with dimensions of 57 cm×20 cm (according to DIN EN ISO 28199-1, section 8.1, version A), coated with a cured cathodic electrocoat (EC) (CathoGuard® 800 from BASF Coatings GmbH), is prepared in analogy to DIN EN ISO 28199-1, section 8.2 (version A). This is followed, in a method based on DIN EN ISO 28199-1, section 8.3, by electrostatic application of an aqueous basecoat material in a single application in the form of a wedge with a target film thickness (film thickness of the dried material; dry film thickness) in the range from 0 μm to 30 μm. The resulting basecoat, without a flash-off time beforehand, is subjected to interim drying in a forced air oven at 80° C. for 5 minutes. The determination of the popping limit, i.e., the basecoat film thickness from which pops occur, is made according to DIN EN ISO 28199-3, section 5.

### 8. Determination of the Incidence of Runs

To determine the propensity toward running, multicoat paint systems are produced in a method based on DIN EN ISO 28199-1 (date: January 2010) and DIN EN ISO 28199-3 (date: January 2010) in accordance with the following general protocol: a perforated steel plate with dimensions of 57 cm×20 cm (according to DIN EN ISO 28199-1, section 8.1, version A), coated with a cured cathodic electrocoat (EC) (CathoGuard® 800 from BASF Coatings GmbH), is prepared in analogy to DIN EN ISO 28199-1, section 8.2 (version A). This is followed, in a method based on DIN EN ISO 28199-1, section 8.3, by electrostatic application of an aqueous basecoat material in a single application in the form of a wedge with a target film thickness (film thickness of the dried material) in the range from 0 μm to 40 μm. The resulting basecoat, after a flash-off time at 18-23° C. of 10 minutes, is subjected to interim drying in a forced air oven at 80° C. for 5 minutes. The panels here are flashed off and subjected to interim drying while standing vertically. The propensity toward running is determined in accordance with DIN EN ISO 28199-3, section 4. In addition to the film thickness at which a run exceeds the length of 10 mm from the bottom edge of the perforation, a determination is made of the film thickness from which a first propensity to run at a perforation can be observed visually.

### 9. Assessment of Streakiness

The streakiness is assessed by means of the method described in patent specification DE 10 2009 050 075 B4. The homogeneity indices stated and defined therein, or the averaged homogeneity index, are equally able to capture the incidence of streaks in the application, despite those indices having been used in the stated patent specification for the purpose of assessing cloudiness. The higher the corresponding values, the more pronounced the streaks visible on the substrate.

### Inventive and Comparative Examples

The inventive and comparative examples below serve to illustrate the invention, but should not be interpreted as limiting.

Unless otherwise stated, the figures in parts are parts by weight, and figures in percent are percentages by weight in each case.

### 1. Production of Aqueous Basecoat Materials

### 1.1 Production of Waterborne Basecoat Materials WBL1 and WBL2

The components listed under “Aqueous phase” in table 1.1 are stirred together in the order stated to form an aqueous mixture. In the next step, a premix is produced in each case from the components listed under “aluminum pigment premix” and “Mica premix”. These premixes are added separately to the aqueous mixture. Stirring takes place for 10 minutes after addition of each premix. Then deionized water and dimethylethanolamine are used to set a pH of 8 and a spray viscosity of 95±10 mPa·s under a shearing load of 1000 s⁻¹, measured using a rotational viscometer (Rheolab QC with C-LTD80/QC heating system from Anton Paar) at 23° C.

Aqueous dispersion AD1 comprises a multistage SCS polyacrylate having a solids content of 25.6 wt % and a pH of 8.85, which is prepared by making use of three different monomer mixtures (A), (B) and (C) employed subsequently in different stages i. to iii. Aqueous polyurethane-polyurea dispersion PD1 has a solids content of 40.2 wt % and a pH of 7.4. Pastes P1 to P5 are pigment pastes (P1 to P3) or filler pastes (P4 and P5). ML1 is a mixing varnish for producing an effect pigment paste.

TABLE 1.1
Production of waterborne basecoat materials WBL1 and WBL2

| | WBL1 | WBL2 |
|---|---|---|
| Aqueous phase: | | |
| 3% Na Mg phyllosilicate solution | 14.4 | 13.4 |
| deionized water | 11.5 | 11.4 |
| 1 -Propoxy-2-propanol | 2.4 | — |
| n-Butoxypropanol | 1.9 | 1.1 |
| 2-Ethylhexanol | 2.8 | — |
| Aqueous binder dispersion AD1 | 22.6 | — |
| Aqueous polyurethane- | 6.6 | — |
| polyurea dispersion PD1 | | |
| Polyurethane dispersion prepared | — | 29.3 |
| as per WO 92/15405, page 13, | | |
| line 13 to page 15, line 13 | | |
| Polyester prepared as per page 28, | 3.8 | 1.5 |
| lines 13 to 33 (example BE1) | | |
| WO 2014/033135 A2 | | |
| Polyester prepared as per example D, | — | 2.2 |
| column 16, lines 37-59 | | |
| of DE 40 09 858 A1 | | |
| Polyurethane-modified polyacrylate | — | 2.2 |
| prepared as per page 7, line 55 to page 8, | | |
| line 23 of DE 4437535 A1 | | |
| Melamine-formaldehyde resin | 2.8 | — |
| (Cymel ® 203 from Allnex) | | |
| Melamine-formaldehyde resin (Maprenal ® | — | 3.3 |
| 909/93IB from INEOS Melamines GmbH) | | |
| 10% Dimethylethanolamine in water | 0.7 | 1.0 |
| Pluriol ® P900, available from | 0.6 | — |
| BASF SE | | |
| 2,4,7,9-Tetramethyl- | — | 0.2 |
| 5-decynediol, 52% in BG | | |
| (available from BASF SE) | | |
| Isobutanol | 3.1 | — |
| Isopropanol | — | 1.8 |
| Butyl glycol | 1.1 | 2.6 |
| Hydrosol A170,available from | — | 0.4 |
| DHC Solvent Chemie GmbH | | |
| Methoxypropanol | — | 2.0 |
| Isopar ® L, available from Exxon Mobil | — | 1.5 |
| 50 wt % solution of Rheovis ® | 0.3 | 0.3 |
| PU1250 in butyl glycol (Rheovis ® | | |
| PU1250 available from BASF SE) | | |
| BYK-347 ® from Altana/ | — | 0.4 |
| BYK-Chemie GmbH | | |
| Yellow paste P1 | 1.7 | 1.7 |
| White paste P2 | 0.7 | 0.7 |
| Black paste P3 | 3.4 | 3.4 |
| Barium sulfate paste P4 | 0.7 | 0.7 |
| Steatite paste P5 | 1.4 | 1.4 |
| Aluminum pigment premix: | | |
| Mixing varnish ML1 | 12.2 | 12.2 |
| Mixture of two commercial aluminum | 4.0 | 4.0 |
| pigments, available from Altana-Eckart | | |
| (Stapa ® Hydrolux 2153 & | | |
| Hydrolux 600 in ratio of 1:1) | | |
| Mica pigment premix: | | |
| Mixing varnish ML1 | 1.0 | 1.0 |
| Commercial mica pigment | 0.3 | 0.3 |
| Mearlin ® Exterior Fine | | |
| Russet 459V from BASF SE) | | |
| Total: | 100.0 | 100.0 |
| Pigment/binder ratio: | 0.3 | 0.3 |
| Solids content (adjusted): | 21.6% | 21.7% |

### 1.2 Production of Waterborne Basecoat Materials WBL3 to WBL6

The components listed under “Aqueous phase” in table 1.2 are stirred together in the order stated to form an aqueous mixture. In the next step, a premix is produced from the components listed under “aluminum pigment premix”. This premix is added to the aqueous mixture. Stirring takes place for 10 minutes after the addition. Then deionized water and dimethylethanolamine are used to set a pH of 8 and a spray viscosity of 85±5 mPa·s under a shearing load of 1000 s⁻¹, measured using a rotational viscometer (Rheolab QC with C-LTD80/QC heating system from Anton Paar) at 23° C.

Within the series WBL3 to WBL4, the fraction of aluminum pigment and hence the pigment/binder ratio was lowered in each case. The same is true of the series WBL6 to WBL6.

TABLE 1.2
Production of waterborne basecoat materials WBL3 to WBL6

| | WBL3 | WBL4 | WBL5 | WBL6 |
|---|---|---|---|---|
| Aqueous phase: | | | | |
| 3% Na/Mg phyllosilicate solution | 17.87 | 17.87 | 17.87 | 17.87 |
| deionized water | 12.23 | 16.74 | 12.07 | 16.68 |
| 2-Ethylhexanol | 1.99 | 1.99 | 1.99 | 1.99 |
| Polyurethane-dispersion prepared | 25.41 | 25.41 | 25.41 | 25.41 |
| as per WO 92/15405, page 13, | | | | |
| line 13 to page 15, line 13 | | | | |
| Daotan ® VTW 6464, | 1.59 | 1.59 | 1.59 | 1.59 |
| available from Allnex | | | | |
| Polyurethane-modified polyacrylate | 2.78 | 2.78 | 2.78 | 2.78 |
| prepared as per page 7, line 55 to | | | | |
| page 8, line 23 of DE 4437535 A1 | | | | |
| 3 wt % aqueous Rheovis ® AS 1130 | 5.08 | 5.08 | 5.08 | 5.08 |
| solution, Rheovis ® AS 1130 | | | | |
| available from BASF SE | | | | |
| Melamine-formaldehyde resin | 3.57 | 3.57 | 3.57 | 3.57 |
| (Cymel ® 1133 from Allnex) | | | | |
| 10% Dimethylethanolamine | 0.95 | 0.95 | 0.95 | 0.95 |
| in water | | | | |
| Pluriol ® P900, available | 0.40 | 0.40 | 0.40 | 0.40 |
| from BASF SE | | | | |
| 2,4,7,9-Tetramethyl-5-decynediol, | 1.35 | 1.35 | 1.35 | 1.35 |
| 52% in BG (available | | | | |
| from BASF SE) | | | | |
| Triisobutyl phosphate | 1.19 | 1.19 | 1.19 | 1.19 |
| Isopropanol | 1.95 | 1.95 | 1.95 | 1.95 |
| Butyl glycol | 2.54 | 2.54 | 2.54 | 2.54 |
| 50 wt % solution of Rheovis ® | 0.24 | 0.24 | 0.24 | 0.24 |
| PU1250 in butyl glycol (Rheovis ® | | | | |
| PU1250 available from BASF SE) | | | | |
| Tinuvin ® 123, available | 0.64 | 0.64 | 0.64 | 0.64 |
| from BASF SE | | | | |
| Tinuvin ® 384-2, available | 0.40 | 0.40 | 0.40 | 0.40 |
| from BASF SE | | | | |
| Aluminum pigment premix: | | | | |
| Aluminum pigment Stapa ® | 7.22 | 2.71 | — | — |
| Hydrolux 600, available | | | | |
| from Altana-Eckart | | | | |
| Aluminum pigment Stapa ® | — | — | 7.38 | 2.77 |
| Hydrolux 200, available | | | | |
| from Altana-Eckart | | | | |
| Butyl glycol | 9.60 | 9.60 | 9.60 | 9.60 |
| Polyester prepared as per example | 3.00 | 3.00 | 3.00 | 3.00 |
| D, column 16, lines 37-59 of | | | | |
| DE 40 09 858 A1 | | | | |
| Total: | 100.00 | 100.00 | 100.00 | 100.00 |
| Pigment/binder ratio: | 0.35 | 0.13 | 0.35 | 0.13 |

### 1.3 Production of Waterborne Basecoat Materials WBL7 to WBL10

The components listed under “Aqueous phase” in table 1.3 are stirred together in the order stated to form an aqueous mixture. In the next step, a premix is produced from the components listed under “aluminum pigment premix”. This premix is added to the aqueous mixture. Stirring takes place for 10 minutes after the addition. Then deionized water and dimethylethanolamine are used to set a pH of 8 and a spray viscosity of 85±5 mPa·s under a shearing load of 1000 s⁻¹, measured using a rotational viscometer (Rheolab QC with C-LTD80/QC heating system from Anton Paar) at 23° C.

Within the series WBL7 to WBL8, the fraction of aluminum pigment and hence the pigment/binder ratio was lowered in each case. The same is true of the series WBL9 to WBL10.

ML2 is a mixing varnish for producing an effect pigment paste.

TABLE 1.3
Production of waterborne basecoat materials WBL7 to WBL10

| | WBL7 | WBL8 | WBL9 | WBL10 |
|---|---|---|---|---|
| Aqueous phase: | | | | |
| 3% Na/Mg phyllosilicate solution | 14.45 | 14.45 | 14.45 | 14.45 |
| Deionized water | 8.99 | 13.50 | 8.83 | 13.44 |
| 2-Ethylhexanol | 1.91 | 1.91 | 1.91 | 1.91 |
| Aqueous binder dispersion AD1 | 26.33 | 26.33 | 26.33 | 26.33 |
| Aqueous polyurethane-polyurea | 6.09 | 6.09 | 6.09 | 6.09 |
| dispersion PD1 | | | | |
| Polyester prepared as per page 28, | 3.01 | 3.01 | 3.01 | 3.01 |
| lines 13 to 33 (example BE1), | | | | |
| WO 2014/033135 A2 | | | | |
| Melamine-formaldehyde resin | 6.67 | 6.67 | 6.67 | 6.67 |
| (Cymel ® 203 from Allnex) | | | | |
| Deionized water | 1.69 | 1.69 | 1.69 | 1.69 |
| Rheovis ® AS 1130 available | 0.22 | 0.22 | 0.22 | 0.22 |
| from BASF SE | | | | |
| 10% Dimethylethanolamine | 0.51 | 0.51 | 0.51 | 0.51 |
| in water | | | | |
| 2,4,7,9-Tetramethyl-5-decynediol, | 0.29 | 0.29 | 0.29 | 0.29 |
| 52% in BG available | | | | |
| from BASF SE) | | | | |
| Butyl glycol | 3.89 | 3.89 | 3.89 | 3.89 |
| 50 wt % solution of Rheovis ® | 0.07 | 0.07 | 0.07 | 0.07 |
| PU1250 in butyl glycol (Rheovis ® | | | | |
| PU1250 available from BASF SE) | | | | |
| Aluminum pigment premix: | | | | |
| Mixing varnish ML2 | 18.66 | 18.66 | 18.66 | 18.66 |
| Aluminum pigment Stapa ® | 7.22 | 2.71 | — | — |
| Hydrolux 600, available | | | | |
| from Altana-Eckart | | | | |
| Aluminum pigment Stapa ® | — | — | 7.38 | 2.77 |
| Hydrolux 200, available | | | | |
| from Altana-Eckart | | | | |
| Total: | 100.00 | 100.00 | 100.00 | 100.00 |
| Pigment/binder ratio: | 0.25 | 0.09 | 0.25 | 0.09 |

2. Investigations and Comparison of the Properties of the Aqueous Basecoat Materials and of their Resultant Coatings
2.1 The above described aqueous basecoat materials were used as coating material compositions. A rotational atomization of each of these coating material compositions was performed and said rotational atomization process was optically monitored. This was done by using the inventive device (1). From a supply unit (4) the coating material compositions were provided to a rotational atomizer (2) provided with a bell cup (3) and the rotational atomization process was optically monitored by making use of both a camera (5) and an optical measurement unit (6) within the device (1). The camera (5) was used for optical capturing of filaments formed by atomization of the coating material composition at the edge of the bell cup (3) and the optical measurement unit (6) was used for optical capturing of drops of a spray, which is formed by atomization of the coating material composition, by a traversing optical measurement through the entire spray. A high-speed camera (HSC) Fastcam SA-Z (from Photron Tokyo, Japan) at an image rate of 100 000 images per second and at a resolution of 512×256 pixels was used as camera (5). The mean filament length was determined according to the determination method described hereinbefore. A commercial single PDA from DantecDynamics (P60, Lexel argon laser, FibreFlow) and/or a commercial time-shift instrument from AOM Systems (SpraySpy®) were used as optical measurement unit (6). Homogeneity and D₁₀ values were determined according to the determination method described hereinbefore.
2.2 Comparison Between Waterborne Basecoat Materials WBL5 and WBL9 in the Incidence of Streakiness and the Homogeneity with the Atomization Spray

The investigations on the waterborne basecoat materials WBL6 and WBL9 (these materials each contain identical amounts of the identical aluminum pigment) with regard to streakiness and spray homogeneity take place as per the methods described above. Table 2.1 summarizes the results.

TABLE 2.1
Comparison of streakiness by homogeneity index
HI (as per patent DE 10 2009 050 075 B4) and the
variables T_{T1}/T_{Total2}, T_{T2}/T_{Total2}, and the ratio thereof

| | WBL5 | WBL9 |
|---|---|---|
| T_{T1}/T_{Total1} (x = 5 mm): | 0.936 | 0.886 |
| T_{T2}/T_{Total2} (x = 25 mm): | 0.697 | 0.463 |
| T_{T1}/T_{Total1} (x = 5 mm)/ | 1.343 | 1.912 |
| T_{T2}/T_{Total2} (x = 25 mm): | | |
| HI (15) | 1.0 | 3.3 |
| HI (25) | 1.0 | 3.6 |
| HI (45) | 3.1 | 3.1 |
| HI (75) | 3.7 | 4.1 |
| HI (110) | 3.5 | 3.9 |
| average HI | 2.5 | 3.6 |

The numbers 15 to 110 in connection with the homogeneity index HI relate to the respective angles in ° selected when carrying out the measurement, with the respective data to be determined being determined a certain number of ° away from the specular angle. HI15, for example, denotes that this homogeneity index pertains to the data captured at a distance of 15° from the specular angle.

WBL6 and WBL9 have identical pigmentation but differ in their basic composition.

The figures in table 2.1 show that the difference in tendency to develop streakiness, which is determined by means of the homogeneity index according to patent DE 10 2009 050 075 B4, correlates with the ratio of T_{T1}/T_{Total1} at x=5 mm (inside) and T_{T2}/T_{Total2} at x=25 mm (outside): The greater the value of the ratio formed from T_{T1}/T_{Total1} and T_{T2}/T_{Total2}, the greater the extent to which nontransparent (NT) particles, i.e., particles containing (effect) pigment, increase from inside to outside in an atomization spray. This means that during application, a material is separated more strongly into regions with different concentrations of (effect) pigments, and hence is more inhomogeneous or more susceptible to the development of streaks.

In contrast to prior-art methods, which measure either only transparent or only nontransparent particles, the method of the invention for characterizing the atomization includes a differentiation between transparent and nontransparent particles, and combines the two pieces of information with one another. As shown by the example given above, this differentiation and combination are necessary in order to understand the processes involved in the atomization of pigmented paints.

### 2.3 Comparison Between Waterborne Basecoat Materials WBL1 and WBL2 in Terms of the Incidence of Pinholes

The investigations on waterborne basecoat materials WBL1 and WBL2 with regard to the incidence of pinholes are made according to the method described above. Tables 2.2a and 2.2b summarize the results.

TABLE 2.2a
Results of the investigations into incidence of pinholes
Discharge rate: 300 ml/min; Speed: 23 000 rpm

| WBL | D₁₀ [μm] | Pinholes |
|---|---|---|
| WBL1 | 32.0 | 0 |
| WBL2 | 44.3 | >100 |

By comparison with WBL1, WBL2 proved to be much more critical with regard to incidence of pinholes. This behavior correlates with a larger value of D₁₀, obtained experimentally in the case of WBL2 in comparison to WBL1 and being a measure of a coarser atomization and of an increased wetness.

TABLE 2.2b
Results of the investigations into incidence of pinholes

| | | | |
|---|---|---|---|
| WBL | Filament length [mm] | Pinholes | Wetness |

Discharge rate: 300 ml/min; speed: 43 000 rpm

| | | | |
|---|---|---|---|
| WBL1 | 0.719 | 0 | 2 |
| WBL2 | 0.763 | >100 | 3 |

Discharge rate: 400 ml/min; speed: 23 000 rpm

| | | | |
|---|---|---|---|
| WBL1 | 1.091 | 0 | 3 |
| WBL2 | 1.124 | >150 | 4 |

By comparison with WBL1, WBL2 proved to be much more critical with regard to the incidence of pinholes, particularly at a relatively low rotary speed of 23 000 rpm. This behavior correlates with a larger filament length, obtained experimentally in the case of WBL2 in comparison to WBL1 and being a measure in turn of a coarser atomization and of an increased wetness.

2.4 Comparison Between Waterborne Basecoat Materials WBL3 to WBL10 with Regard to the Assessment of Cloudiness, the Incidence of Pinholes, and the Film Thickness-Dependent Leveling

The investigations on waterborne basecoat materials WBL3 to WBL10 with regard to the assessment of cloudiness, of pinholes, and of the film thickness-dependent leveling are made in accordance with the methods described above. Tables 2.3a, 2.3b, 2.4a and 2.4b summarize the results.

TABLE 2.3a
results of the investigations into pinholes and cloudiness
(measured with the cloud-runner from Byk-Gardner)

| | | Discharge rate: 300 ml/min; speed: 43 000 rpm | | | |
|---|---|---|---|---|---|
| WBL | D₁₀ [μm] | Pinholes | Mottling15 | Mottling45 | Mottling60 |
| WBL3 | 23.5 | >100 | 3.8 | 4.2 | 4.1 |
| WBL4 | 26.8 | >100 | 2.9 | 4.4 | 3.5 |
| WBL6 | 31.5 | >100 | 4.8 | 4.4 | 6.3 |
| WBL7 | 19.1 | 0 | 3.3 | 3.9 | 3.9 |
| WBL8 | 15.9 | 0 | 2.7 | 3.8 | 3.4 |
| WBL10 | 15.6 | 0 | 4.1 | 4.4 | 6.1 |

In direct comparison of the sample pairings WBL3 and WBL7, WBL4 and WBL8, and WBL6 and WBL10, respectively, each containing the same pigment and also the same amount of pigment, it is found that at a discharge rate of 300 ml/min and a speed of 43 000 rpm, materials WBL7, WBL8, and WBL10 each have a smaller D₁₀ than the corresponding reference sample WBL3, WBL4 and WBL6 and therefore undergo finer atomization. This is reflected in significantly better pinhole robustness and also in a lower cloudiness.

TABLE 2.3b
Results of the investigations into pinholes and cloudiness
(measured with the cloud-runner from Byk-Gardner)

| | Filament | | | | |
|---|---|---|---|---|---|
| | length | Discharge rate: 300 ml/min; speed: 43 000 rpm | | | |
| WBL | [mm] | Pinholes | Mottling15 | Mottling45 | Mottling60 |
| WBL3 | 0.591 | >100 | 3.8 | 4.2 | 4.1 |
| WBL4 | 0.717 | >100 | 2.9 | 4.4 | 3.5 |
| WBL5 | 0.775 | >100 | 3.4 | 5.3 | 4.9 |
| WBL6 | 0.820 | >100 | 4.8 | 4.4 | 6.3 |
| WBL7 | 0.578 | 0 | 3.3 | 3.9 | 3.9 |
| WBL8 | 0.699 | 0 | 2.7 | 3.8 | 3.4 |
| WBL9 | 0.676 | 0 | 3.8 | 4.7 | 5.6 |
| WBL10 | 0.768 | 0 | 4.1 | 4.4 | 6.1 |

In direct comparison of the sample pairings WBL3 and WBL7, WBL4 and WBL8, WBL5 and WBL9, and WBL6 and WBL10, respectively, each containing the same pigment and also the same amount of pigment, it is found that, at a discharge rate of 300 ml/min and a speed of 43 000 rpm, basecoat materials WBL7 to WBL10 each have a smaller filament length than the corresponding reference sample WBL3 to WBL6 and therefore undergo finer atomization. This is reflected in significantly better pinholing robustness and also in a lower cloudiness.

TABLE 2.4a
Results of the investigations into film thickness-dependent leveling

| | | Discharge rate: 300 ml/min, Speed: 43 000 rpm | | | | | |
|---|---|---|---|---|---|---|---|
| | | 10-15 μm | | 15-20 μm | | 20-25 μm | |
| WBL | D₁₀ [μm] | SW | DOI | SW | DOI | SW | DOI |
| WBL3 | 23.5 | 11.5 | 77.3 | 16.1 | 72.2 | 17.2 | 71.6 |
| WBL5 | 30.1 | 14.7 | 64.6 | 19.9 | 63.8 | 24.0 | 60.8 |
| WBL4 | 26.8 | 8.60 | 85.05 | 11.90 | 83.82 | 14.30 | 82.73 |
| WBL6 | 31.5 | 10.40 | 74.35 | 15.10 | 71.44 | 18.70 | 68.37 |

WBL3 and WBL5 each have a pigment/binder ratio of 0.35, whereas WBL4 and WBL6 each have a pigment/binder ratio of 0.13. The experimental results show a correlation between the D₁₀ values, and the resultant atomization properties, and the appearance/leveling, here as a function of the film thickness: on comparison with the samples with identical pigment/binder ratio of 0.35 (WBL3 and WBL5) and 0.13 (WBL4 and WBL6) it is found that a larger D₁₀ value, in other words a coarser and hence wetter atomization, leads to poorer leveling, as illustrated by the short wave and DOI figures obtained.

TABLE 2.4b
Results of the investigations into film thickness-dependent leveling

| | Filament | Discharge rate: 300 ml/min, speed: 43 000 rpm | | | | | | |
|---|---|---|---|---|---|---|---|---|
| | length | 10-15 μm | | 15-20 μm | | 20-25 μm | | |
| WBL | [mm] | SW | DOI | SW | DOI | SW | DOI | Wetness |
| WBL3 | 0.591 | 11.5 | 77.3 | 16.1 | 72.2 | 17.2 | 71.6 | 2 |
| WBL4 | 0.775 | 14.7 | 64.6 | 19.9 | 63.8 | 24.0 | 60.8 | 4 |
| WBL5 | 0.717 | 8.60 | 85.05 | 11.90 | 83.82 | 14.30 | 82.73 | 3 |
| WBL6 | 0.820 | 10.40 | 74.35 | 15.10 | 71.44 | 18.70 | 68.37 | 4 |

WBL3 and WBL5 each have a pigment/binder ratio of 0.35, whereas WBL4 and WBL6 each have a pigment/binder ratio of 0.13. The experimental results show a correlation between the filament lengths, or the resultant atomization properties, and the appearance/leveling, here as a function of the film thickness: on comparison of the samples with identical pigment/binder ratio of 0.35 (WBL3 and WBL5) and 0.13 (WBL4 and WBL6), it is found that a larger filament length, in other words a coarser and hence wetter atomization, leads to poorer leveling, as illustrated by the short wave and DOI figures obtained.

6.4 The examples demonstrate that by means of the device and method of the invention it is possible to make predictions about the atomization of a paint that correlate with qualitative properties of the final coating (number of pinholes, cloudiness or leveling, and appearance) and in particular correlate better than other methods in the prior art. The method of the invention therefore enables a simple and efficient method for quality assurance. It may help to focus paint developments and in so doing to remove the need at least partly for costly and inconvenient coating operations on model substrates (including baking of the materials).

1. A device for performing and optically monitoring a rotational atomization of a coating material composition, wherein said device comprises
at least one rotational atomizer, which comprises as application element a mountable bell cup capable of rotation,
at least one supply unit for supplying a coating material composition to the rotational atomizer,
at least one camera for optical capturing of filaments formed by atomization of the coating material composition at the edge of the bell cup, and
at least one optical measurement unit for optical capturing of drops of a spray, which is formed by atomization of the coating material composition, by a traversing optical measurement through the entire spray.

2. The device according to claim 1, characterized in that the atomizer is in a tilted position and the at least one camera and the at least one optical measurement unit are independently of each other positioned within the device in relation to the tilted atomizer at a tilt angle of 0° to 90°.

3. The device according to claim 1, characterized in that both the at least one camera and the at least one optical measurement unit are movable and/or adjustable within the device.

4. The device according to claim 1, characterized in that the at least one rotational atomizer and the at least one supply unit each have a fixed position within the device or in that at least the rotational atomizer has an adjustable position.

5. The device according to claim 1, characterized in that the at least one camera is capable of recording at least 30,000 to 250,000 images per second of the bell cup and its edge during atomization.

6. The device according to claim 1, characterized in that the at least one optical measurement unit contains at least one laser and optionally also at least one detector and allows performing of scattered light investigations on the drops contained within the spray formed upon atomization.

7. The device according to claim 1, characterized in that the at least one optical measurement unit is a means for performing phase Doppler anemometry (PDA) and/or for performing time-shift technique (TS).

8. The device according to claim 1, characterized in that the bell cup of the rotational atomizer is straight serrated, cross serrated or non-serrated.

9. The device according to claim 1, characterized in that the device is a measurement chamber and further contains a shielding unit for collecting the sprayed coating material composition.

10. The device according to claim 1, characterized in that the at least one rotational atomizer, the at least one supply unit, the least one camera and the at least one optical measurement unit of the device are positioned on a mobile rack such that at least part of the device is movable.

11. The device according to claim 10, characterized in that the device is positioned within a spray booth or spray station or is positioned in front of a spray booth or spray station.

12. A method of using the device according to claim 1 for performing and optical monitoring a rotational atomization of a coating material composition.

13. A method for determining the mean length of filaments formed on rotational atomization of a coating material composition and/or for determining at least one characteristic variable of the drop size distribution within a spray and/or the homogeneity of said spray, the spray being formed on the edge of the bell cup of an rotational atomizer during rotational atomization of a coating material composition, characterized in that the method is carried out by making use of the device according to claim 1.

14. The method of claim 13, the method comprising simultaneously determining the mean length of filaments formed on the edge of the bell cup of an rotational atomizer during rotational atomization of a coating material composition and at least one characteristic variable of the drop size distribution within the spray and/or the homogeneity of said spray, or determining the mean length of filaments formed on the edge of the bell cup of an rotational atomizer during rotational atomization of a coating material composition and at least one characteristic variable of the drop size distribution within the spray and/or the homogeneity of said spray one after another, wherein no particular order is needed.

15. The method of claim 13, characterized in that the method comprises at least the following steps (Ia), (IIa), and (IIIa) and/or (Ib), (IIb), and (IIIb):
(Ia) atomization of the coating material composition by means of the rotational atomizer of the device,
(IIa) optical capture of the filaments formed on atomization as per step (Ia) at the edge of the bell cup, by means of the at least one camera, and
(IIIa) digital evaluation of the optical data obtained by the optical capture as per step (IIa), to give the mean length of those filaments formed on atomization that are located at the edge of the bell cup,
and/or
(Ib) atomization of the coating material composition by means of the rotational atomizer of the device, the atomization producing a spray,
(IIb) optical capture of the drops of the spray formed by atomization as per step (Ib), by a traversing optical measurement through the entire spray, by means of the at least one optical measurement unit, and
(IIIb) determination of at least one characteristic variable of the drop size distribution within the spray and/or of the homogeneity of the spray, on the basis of optical data obtained by the optical capture as per step (IIb).
